(19) United States
(12) Patent Application Publication
(10) Pub. No.: US 2005/0226265 A1
(43) Pub. Date: Oct. 13, 2005

(54) Inter-ring connection device and data transfer control method

(76) Inventor: Kou Takatori, Kawasaki (JP)

Correspondence Address: KATTEN MUCHIN ROSENMAN LLP, 575 MADISON AVENUE, NEW YORK, NY, 10022-2585, US

(21) Appl. No.: 11/140,373

(22) Filed: May 27, 2005

Related U.S. Application Data
(63) Continuation of application No. PCT/JP03/05269, filed on Apr. 24, 2003.

(51) Int. Cl. H04L 12/403

(52) U.S. Cl. 370/452

(57) ABSTRACT

An inter-ring connection device connecting at least two rings, each consisting of network devices connected in a ring shape. Each of the network devices transmits/receives topology constituting data including its address and information indicating its position. Each of the rings functions as a network device and generates a topology map. The inter-ring connection device includes setting information storage means and transfer means. The setting information storage means stores one of the setting information for creating a topology map of a physical ring and setting information for creating a topology map of a virtual ring striding over two physical rings. When transferring topology constituting data to another adjacent network device, only if the setting information is the information for creating a topology map of a virtual ring, the transfer means transfers the topology constituting data to the other adjacent network device striding over two physical rings.

This is a continuation of Application PCT/JP2003/005269, filed on Apr. 24, 2003.

### BACKGROUND OF THE INVENTION

1. Field of the Present Invention

The present invention relates to an inter-ring connection device and a data transfer control method on the occasion of configuring a network by a plurality of packet rings.

2. Description of the Related Art

In a metro area network, by contrast with a conventional SONET (Synchronous Optical Network)/SDH (Synchronous Digital Hierarchy) ring, a packet ring (RPR: Resilient Packet Ring) for transferring an Ethernet (Ethernet (registered trademark): a network pursuant to IEEE 802.3) packet directly on the ring, has been focused over the recent years. At the present, the standardization of the packet ring is underway at the IEEE 802.17 Committee, aiming at completion in June in 2003.

The packet ring is classified as a ring topology network, having an Inner ring and an Outer ring, for transferring the data in a way that determines a data destination (an inner side or an outer side) on a packet-by-packet basis. In the packet ring, each of network devices (called [station]) configuring the ring determines a data transfer direction by referring to a destination address set in the packet each time.

In the packet ring, each network device recognizes a topology of the whole ring in such a way that each of the network devices belonging to the ring sends a topology configuring packet containing information about a self-device to other network devices in the ring. A method of configuring the topology by use of the topology configuring packet in the packet ring will be explained as follows.

In an example shown in FIG. 1, to begin with, a station 2 sets a value “255” in a TTL (Time-To-Live) field such as TTL=255 (initial value) in the topology configuring packet containing a MAC (Media Access Control) address of the station 2, and thus broadcasts the topology configuring packet on the inner side. A station 3 firstly receiving the topology configuring packet, as the TTL value of the received packet is 255 (initial value), recognizes that the station 2 exists in a position corresponding to a hop count “1” on the outer side as viewed from the station 3 itself. The station 3 sets a value “−1” in a TTL field such as TTL=254 in the topology configuring packet received from the station 2, and thus sends the topology configuring packet to a station 4.

Subsequently, the station 4 receiving the topology configuring packet having the TTL value “254” recognizes that the station 2 exists in a position corresponding to a hop count “2” on the outer side as viewed from the station 4 itself. Thereafter, all the stations (stations 5 through 10 and the station 1) located posterior to the station 4 in the inner ring recognize the existence of the station 2 and further the hop counts up to the station 2 on the outer side in the same procedure. Similarly, the station 2 sends the topology configuring packet to the outer side. With this operation, the station 1 and the stations 3 through 10 within the packet ring get able to recognize the MAC address of the station 2 and the hop counts on the inner side up to the station 2. Accordingly, each of the station 1 and the stations 3 through 20 can recognize the MAC address and the inner- and outer-side positions (hop counts) with respect to the station 2.

Moreover, the topology configuring packet is sent from all the stations on the ring as well as from the station 2. Hence, each station can collect pieces of information (the MAC addresses, and the inner- and outer-side hop counts) of all the stations on the ring.

FIG. 2 shows an example of a topology map that can be retained by the station 2 in FIG. 1. Each of the stations on the packet ring generates the topology map in the procedure described above and can thereby judge which direction of the ring the packet can be transferred to other station on the ring at a shortest distance.

FIG. 3 shows a case of how the packet is added (Packet Add) from the station 2 and dropped (Packet Drop) from the station 6. In this case, the station 2 can judge from the topology map that the station 2 gains a shorter distance to the station 6 by transferring a data packet in the inner direction.

Moreover, the packet ring enables execution of a fault protection technique for protecting the transfer packet from a fault occurred in the ring by utilizing the generated topology map. The fault protection technique generally has the following two types.

One type is a technique called [Steering], wherein the packet transfer direction is promptly changed so as to “steer” clear of a failed position if the fault occurred in the packet ring. FIG. 4 shows an example of carrying out Steering. In FIG. 4, the station 2, if the fault occurs between the station 4 and the station 5, receives a fault notifying packet sent from other station and can recognize from this packet that the fault occurred between the station 4 and the station 5. In this case, the station 2 can switch over before the fault so that the data packet being sent to the inner ring of the packet ring is then sent to the outer ring. Owing to steering, the packet added from the station 2 reaches the station 6 via the outer ring.

Another type is a technique called [Wrapping] for carrying out the fault protection by looping back the packet transfer on both sides of the failed point where the fault occurs in the ring. FIG. 5 shows the wrapping operation in case the fault occurs between the station 4 and the station 5 in the packet ring shown in FIG. 3. In the example illustrated in FIG. 5, the station 4 wraps the transfer direction of the data packet added from the station 2 to the outer ring from the inner ring. The data packet is not, though passing through the station 6 on the outer ring, dropped at this time but is, after being wrapped (looped back) to the inner ring at the station 5, dropped at the station 6. The stations effecting none of wrapping have no necessity of executing the protection process.

The packet ring can be configured to assure the fault protection switchover of which a speed is as fast as within 50 ms if within the physical packet ring (physical ring) by employing the ring protection means called “Steering” and “Wrapping”.

By the way, there is considered a case of configuring a network, wherein two or more packet rings described above are prepared, the packet rings are interconnected by a single network device, and the data packet is transferred across between the plurality of rings. In this case, if a fault occurs in the network device serving as an interconnecting point between the rings, it is impossible to save the packet transferred across between the rings.

For taking a measure for such a case, there is generally adopted a method of providing, as shown in FIG. 6, a plurality of interconnecting points (stations) between the rings, and, if a fault occurs in the interconnecting point, running Spanning Tree Protocol over the plurality of rings, thereby effecting the protection switchover.

For others, there are technologies disclosed in Japanese Patent Application Laid-Open Publication No. 10-341251 and Japanese Patent Application Publication No. 3225029 as the conventional technologies related to the present invention.

The method using the spanning tree described above needs to implement a fault switchover protocol such as Spanning Tree Protocol other than the ring protection in all the network devices configuring the plurality of packet rings. Further, the method described above has a problem that it is difficult to execute the fault protection switchover that is as fast as “Steering” and “Wrapping”.

### SUMMARY OF THE INVENTION

It is an object of the present invention to provide an inter-ring connection device and a data transfer control method that are capable of obviating the problems described above and actualizing high-speed protection switchover even in a network configured by a plurality of packet rings.

For solving the problems described above, the present invention takes the following constructions. Namely, according to a first mode of the present invention, there is provided an inter-ring connection device, a plurality of network devices being connected in a ring topology, the network device each sending topology configuring data containing an address of the self-device and information showing a position of the self-device onto the ring, receiving the topology configuring data from each of the other network devices and generating a topology map, at least two pieces of the inter-ring connection devices being provided between the connection target rings in order to establish an interconnection between the physical rings and each functioning as a network device belonging to the respective physical rings, the inter-ring connection device comprising setting information storage unit storing one set of setting information for generating a topology map of the physical ring or another set of setting information for generating a topology map of a virtual ring extending over between the physical rings, and transferring unit transferring, in the case of transferring the topology configuring data received from the adjacent network device to the other adjacent network device, if the setting information stored on the setting information storage unit is the setting information for generating the topology map of the physical ring, this topology configuring data to the other adjacent network device on the physical ring to which the network device defined as a source device of this topology configuring data belongs, and transferring, if the setting information is the setting information for generating the topology map of the virtual ring, this topology configuring data to the other adjacent network device belonging to the physical ring different from the physical ring to which the source network device belongs.

Preferably, according to the first mode of the present invention, the inter-ring connection device may further comprise a retaining unit retaining the topology map of each of the physical rings being connected by the inter-ring connection device, and a route determining unit determining, in the case of receiving data set based on the topology map of the virtual ring and containing information regarding a source network device and a destination network device striding over the physical rings, a shortest route, on the physical ring to which the destination network device belongs, from the inter-ring connection device to the destination network device by referring to the topology map of the physical ring to which the destination network device belongs, wherein the transferring unit may transfer the data to the adjacent network device located on the shortest route on the basis of a result of the determination by the route determining unit.

Preferably, according to the first mode, the route determining unit may be constructed to determine a route exhibiting a minimum hop count as the shortest route on the basis of a hop count between the self-device and the destination network device.

Preferably, according to the first mode, the route determining unit may determines, as the shortest route, a route exhibiting a minimum total sum of cost values between the network devices on the physical rings and between the network device and the inter-ring connection device.

Preferably, according to the first mode of the present invention, the inter-ring connection device may further comprise notification-of-congestion receiving unit for receiving a notification of congestion that indicates a congestion of the network device from the network device, wherein the route determining unit may, when receiving the notification of congestion, determine a route that does not traverse a point of the congest, for the data to be transferred to the physical ring to which the network device as a source device of this notification of congestion belongs.

According to the first mode of the present invention, the inter-ring connection device can determine a transfer route by judging which ring, the physical ring or the virtual ring, the data to be transferred across between the rings is transferred within. Moreover, when determining this transfer route, it is possible to determine the transfer route taking account of the hop count up to the transfer destination, the total sum of the cost values up to the transfer destination and the congested state of the station existing on the transfer route.

According to a second mode of the present invention, there is provided an inter-ring connection device, a plurality of network devices being connected in a ring topology, the network device each sending topology configuring data containing an address of the self-device and information showing a position of the self-device onto the ring, receiving the topology configuring data from each of the other network devices and generating a topology map, at least at least one piece of the inter-ring connection device being provided between the connection target rings in order to establish an interconnection between the physical rings and each functioning as a network device belonging to the respective physical rings, the inter-ring connection device comprising setting information storage unit storing one set of setting information for generating a topology map of the physical ring or another set of setting information for generating a topology map of a virtual ring extending over between the physical rings, transferring unit transferring, in the case of transferring the topology configuring data received from the adjacent network device to the other adjacent network device, if the setting information stored on the setting information storage unit is the setting information for generating the topology map of the physical ring, this topology configuring data to the other adjacent network device on the physical ring to which the network device defined as a source device of this topology configuring data belongs, and transferring, if the setting information is the setting information for generating the topology map of the virtual ring, this topology configuring data to the other adjacent network device belonging to the physical ring different from the physical ring to which the source network device belongs, a switching line transferring the data striding over the physical rings through a pass switch in the inter-ring connection device, a path through line directly transferring the data striding over the physical rings not through the pass switch, fault detecting unit detecting a fault of control unit executing software for making the self-device function as the inter-ring connection device, and switching unit switching over, when the fault is detected by said fault detecting unit, a line transferring the data striding over the physical rings from said switching line to said path through line.

According to the second mode of the present invention, only one inter-ring connection device is provided between the rings, and, even if a device fault is detected, the data can be forcibly sent onto the other ring by switching over the route for transferring the data.

Further, according to a third mode of the present invention, there is provided an inter-ring connection device, a plurality of network devices being connected in a ring topology, the network device each sending topology configuring data containing an address of the self-device and information showing a position of the self-device onto the ring, receiving the topology configuring data from each of the other network devices and generating a topology map, the inter-ring connection device being provided in a physical ring, functioning as the network device belonging to this physical ring and performing data communications with a predetermined network device belonging to other physical ring, the inter-ring connection device comprising setting information storage unit storing one set of setting information for generating a topology map of the physical ring or another set of setting information for generating a topology map of a virtual ring extending over between the physical rings, and transferring unit transferring, in the case of transferring the topology configuring data received from the adjacent network device to the other adjacent network device, if the setting information stored on the setting information storage unit is the setting information for generating the topology map of the physical ring, this topology configuring data to the other network device on the physical ring to which the self-device belongs, and transferring, if the setting information is the setting information for generating the topology map of the virtual ring, this topology configuring data towards a predetermined network device.

Preferably, according to the third mode of the present invention, the inter-ring connection device may be connected to the predetermined network device via a relay network using a protocol different from a protocol employed for data transfer on the physical ring, and the inter-ring connection device may translate the topology configuring data received from the adjacent network device into a format corresponding to the relay network, and may thus send the data to the predetermined network.

According to the third mode of the present invention, even in a case where the data is sent through the relay network employing the protocol different from the protocol on the ring, the data format can be translated corresponding to this relay network and can be thus transmitted.

The present invention may be a method by which the inter-ring connection device executes any one of the processes described above in order to control the data transfer.

### BRIEF DESCRIPTION OF THE DRAWINGS

FIG. 1 is a view showing a topology configuring process in a packet ring;

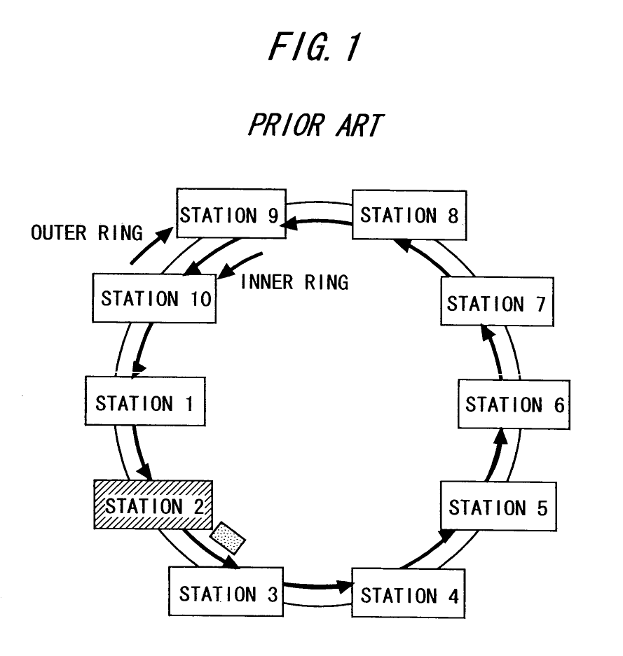

FIG. 2 is a view showing an example of a topology map in a station 2 in FIG. 1;

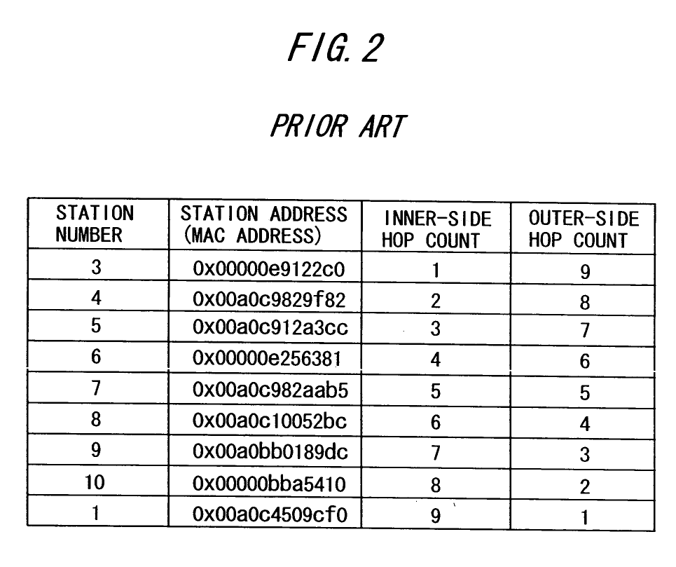

FIG. 3 is a view showing an example of forwarding a packet in the packet ring;

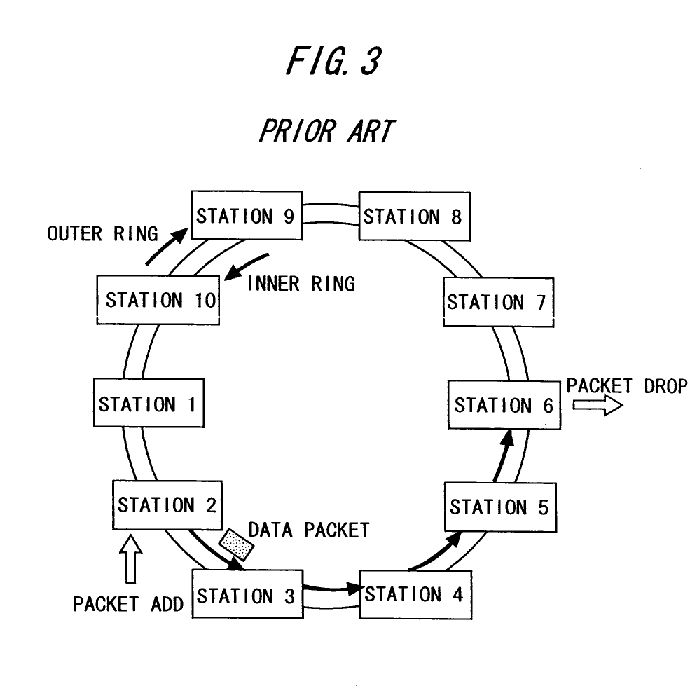

FIG. 4 is a view showing an example of performing “Steering”;

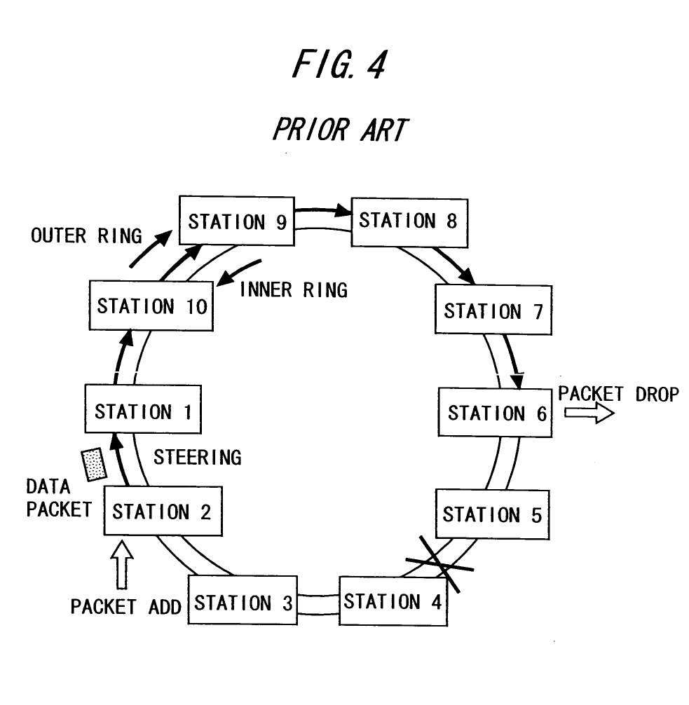

FIG. 5 is a view showing an example of performing “Wrapping”;

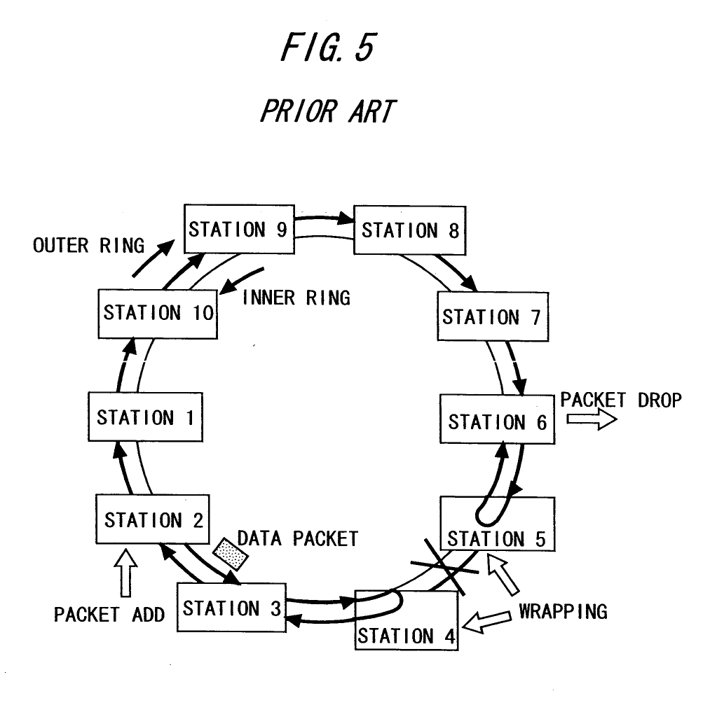

FIG. 6 is a view showing one example of a network configured by a plurality of packet rings;

FIG. 7 is a view showing an example of a packet route in a network architecture shown in FIG. 6;

FIG. 8 is a diagram showing a topology map retained by a station A in the network architecture shown in FIG. 6;

FIG. 9 is a diagram showing an example of a transferring method and a packet format in the network architecture shown in FIG. 6;

FIG. 10 is a view showing an example of a packet route when a fault occurs on one device establishing an interconnection between the rings in the network architecture shown in FIG. 6;

FIG. 11 is a view showing a topology configuring example in a first embodiment of the present invention;

FIG. 12 is a view showing a system architecture of a conventional station and a route of the packet received from other station;

FIG. 13 is a view showing a system architecture of each of the stations establishing the interconnection between the rings and a route of the packet received from other station in the first embodiment of the present invention;

FIG. 14 is a diagram showing a topology map retained by the station A in the first embodiment of the present invention;

FIG. 15 is a view showing a transferring method and a packet format in the first embodiment of the present invention;

FIG. 16 is a view showing a network architecture in a modified example 1;

FIG. 17 is a diagram showing a topology map retained by a station C in the modified example 1;

FIG. 18 is a view showing an example of the packet route in the modified example 1;

FIGS. 19A and 19B are a diagram showing physical ring topology maps retained by the station C in the modified example 1;

FIG. 20 is a view showing a network architecture in a modified example 2;

FIGS. 21A and 21B are a diagram showing physical ring topology maps retained by the station C in the modified example 2;

FIG. 22 is a view showing an example of the packet route when a station I is in a congested state;

FIG. 23 is a view showing a network architecture in a modified example 4;

FIG. 24 is a view showing a network architecture in a second embodiment of the present invention;

FIG. 25 is a view showing an example of the packet route in the second embodiment of the present invention;

FIG. 26 is a diagram showing a topology map retained by a station F in the second embodiment of the present invention;

FIG. 27 is a view showing a transferring method and a packet format in the second embodiment of the present invention;

FIG. 28 is a view showing a packet route when the fault occurs in the station C in the network architecture shown in FIG. 24; and

FIG. 29 is a view showing a system architecture of the station C shown in FIG. 28.

### DESCRIPTION OF THE PREFERRED EMBODIMENTS

Embodiments of the present invention will hereinafter be described with reference to the drawings. Note that the descriptions of the embodiments are exemplifications, and the configuration of the present invention is not limited to the following descriptions.

### First Embodiment

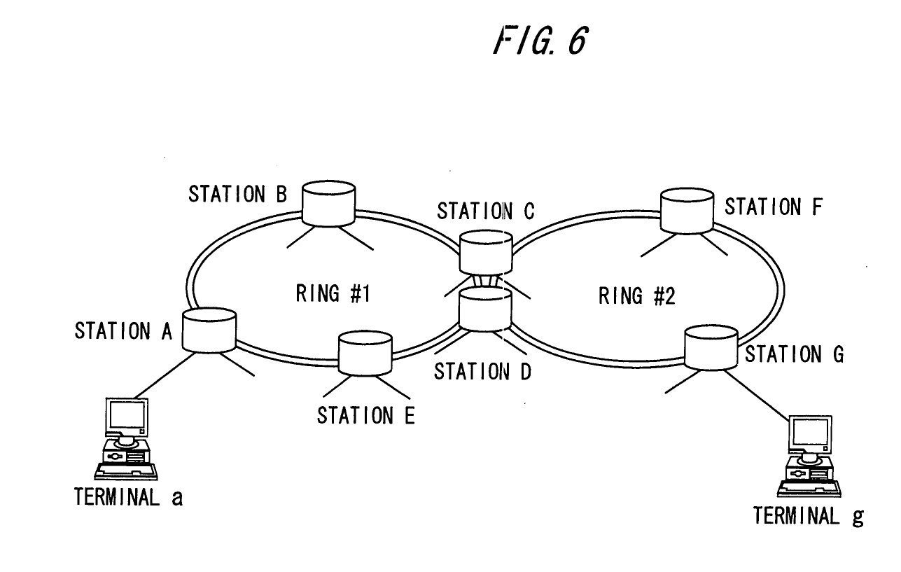

Next, a first embodiment for actualizing the present invention will be explained with reference to FIGS. 6 through 15.

<Outline>

An outline of the first embodiment will be explained.

To start with, a network architecture in the first embodiment for actualizing the present invention will be described with reference to FIG. 6. FIG. 6 shows one example of a network configured by a plurality of packet rings (RPR rings). The network illustrated in FIG. 6 includes physical packet rings (physical rings) “#1” and “#2”. The packet rings “#1” and “#2” are configured by connecting a plurality of stations (RPR nodes) in a ring (circular) topology. Each of the stations configuring the packet rings “#1” and “#2” can generate and retain a topology map corresponding to the physical ring.

Each of the stations is so constructed as to be included in a network device (a device capable of configuring the ring), and can accommodate a terminal that supports Ethernet. In the example shown in FIG. 6, a station A accommodates a terminal a, and a station G accommodates a terminal g. Further, stations C and D are inter-ring connection devices taking a role of connecting the packet rings “#1” and “#2” to each other. The discussion in the first embodiment will be made, wherein the device configuring the ring is referred to as the station.

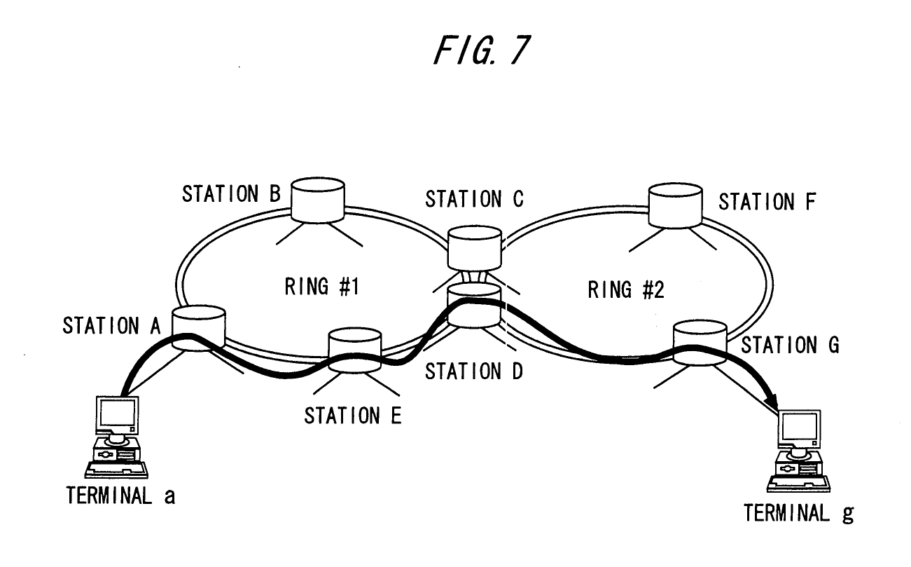

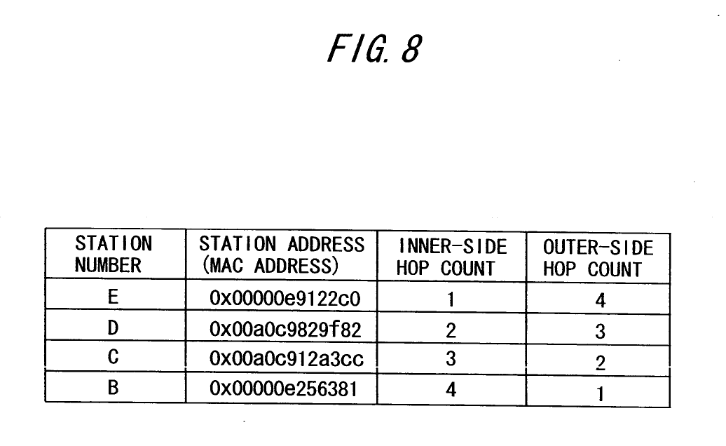

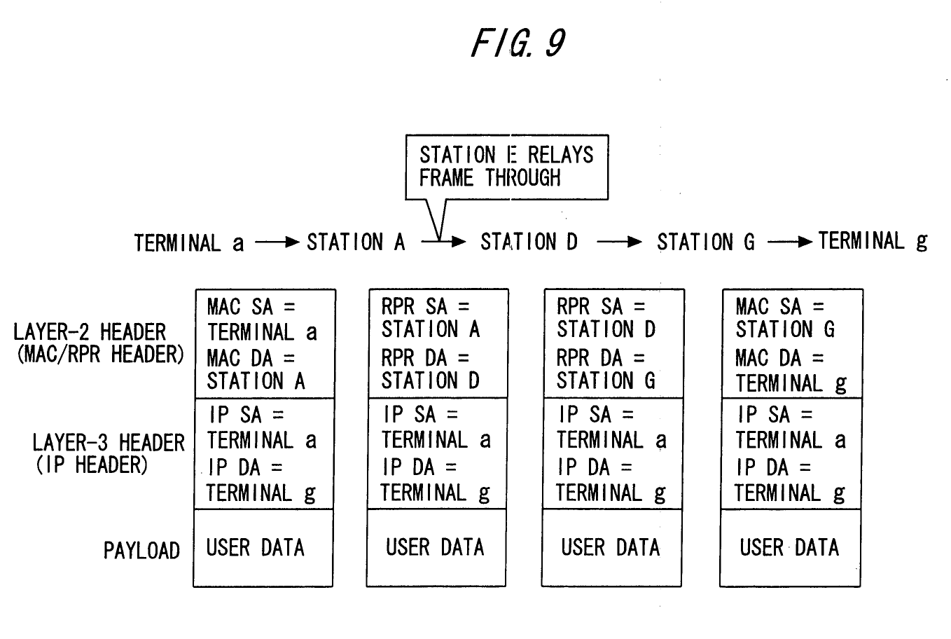

In the network configured by the plurality of packet rings shown in FIG. 6, when forwarding a packet from the terminal a to the terminal g, for example, a route shown in FIG. 7 can be adopted as a normal packet route. In the network architecture shown in FIG. 6, the topology map generated by the station A consists of pieces of information about the respective stations belonging to the ring “#1” shown in FIG. 8. Further, in the network architecture shown in FIG. 6, when the packet is forwarded from the terminal a to the terminal g, a packet format of the packet to be forwarded becomes as shown in FIG. 9. Normally, if the station D gets into a fault, in the case of the packet (e.g., the packet forwarded from the station E to the station C) forwarded within only the ring “#1”, high-speed protection switchover is conducted as by the conventional ring protection.

In the case of forwarding the packet across the plurality of rings shown in FIG. 6, however, it is difficult to switch over the protection at a high speed in the same way as by the conventional ring protection for the transfer packet forwarded across between the rings from the station A to the station G.

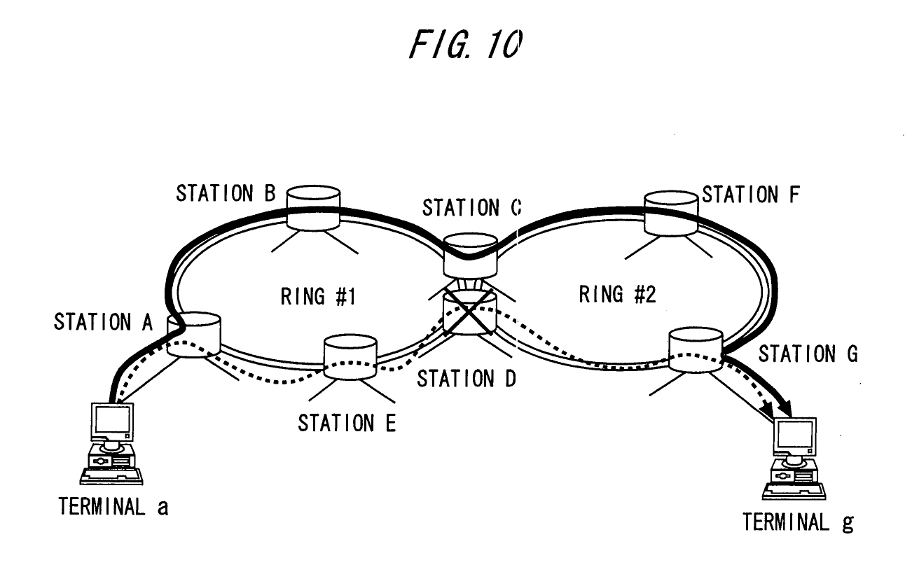

The packet, when forwarded from the terminal a to the terminal g, is sent through the station D at which the rings “#1” and “#2” connect to each other. If the station D falls into a state incapable of continuing the operation due to a fault, the station A is required to switch over a packet route so that the packet steers clear of the station D. To be specific, as illustrated in FIG. 10, when the station D gets into the fault, the station A must switch over a MAC destination address (MAC DA) of the packet to the station C from the station D.

Protection specifications (steering and wrapping) of the packet ring in the present situation can not support a change in the MAC destination address (MAC DA) in such a state. This is because the protection specifications (steering and wrapping) of the packet ring in the present situation have only a function of changing a path, though the destination is basically the same. Hence, in the network configured by employing two or more packet rings, all the stations configuring the packet rings need to implement Spanning Tree Protocol, a protection switchover function of a upper layer (e.g., an IP layer) than the RPR layer, and so on. In addition, it is extremely difficult to actualize the high-speed protection equal to the conventional ring protection.

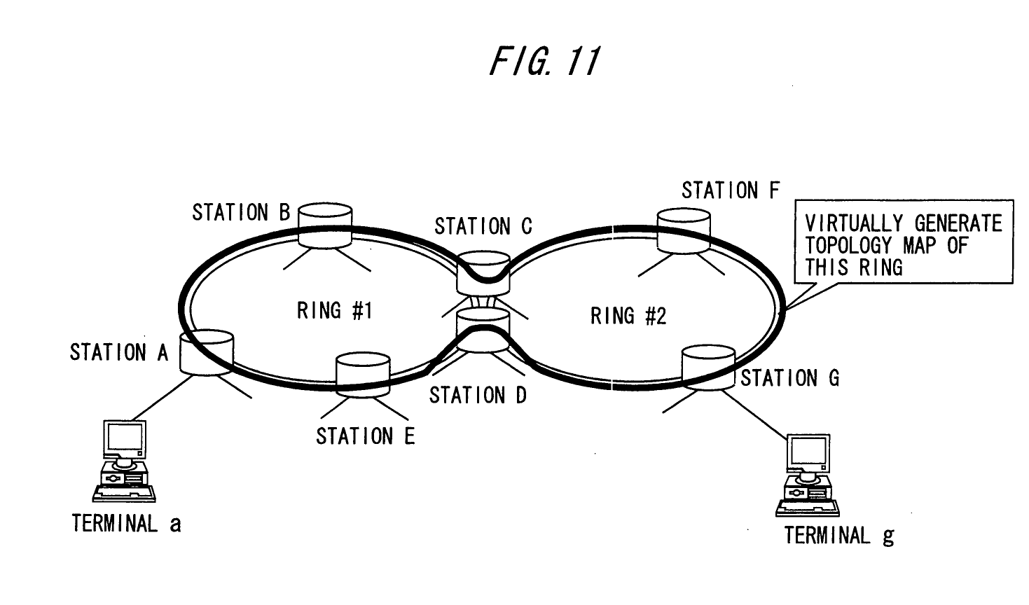

In the first embodiment, in the network architecture as illustrated in FIG. 6, the actualization of the present invention involves generating a topology map about virtual packet rings (virtual rings) as shown in FIG. 11.

In the example shown in FIG. 11, a topology configuring packet is sent and received (forwarded) across between the rings via the stations C and D that establish the inter-ring connection. The station C handles the topology configuring packet as if the station C itself neighbors to stations B and F on the physical rings, and the station D handles the topology configuring packet as if the station D itself neighbors to stations E and G on the physical rings. Then, the stations other than the stations C and D execute the process (of generating the topology map) as usual. Thus, all the stations shown in FIG. 11 can, separately from the topology map of the physical rings with respect to each ring “#1” and “#2”, retain a topology map of a virtual ring as the network, wherein the respective physical rings are assumed to be one virtual ring configured by the stations such as A-B-C-F-G-D-E-A.

<System Architecture of Station and Configuring of Topology>

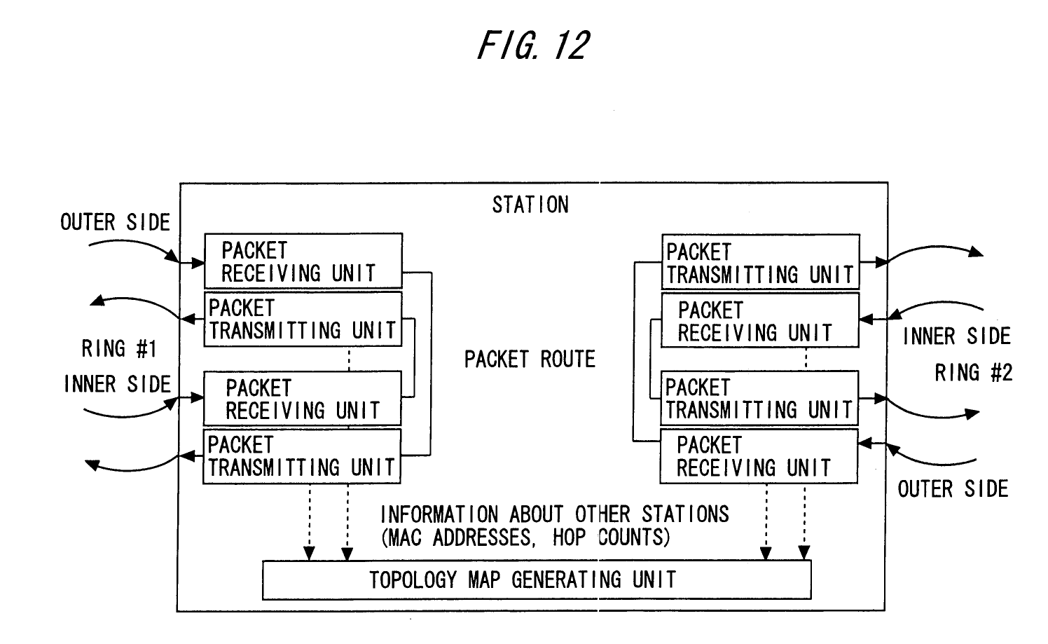

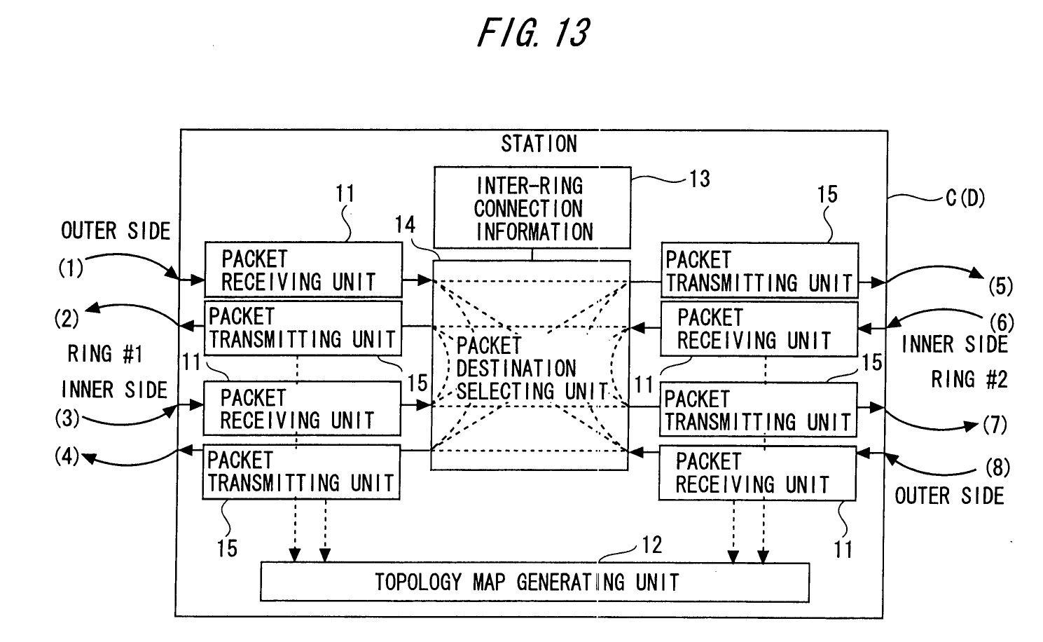

Next, a system architecture of the station and a topology configuring process as a concomitant thereof will be explained with reference to FIGS. 12 and 13. FIG. 12 shows a conventional system architecture of the station and a route of the packet received from other station. FIG. 13 shows a system architecture of each of the stations C and D (the inter-ring connection devices) and a route of the packet received from other station in the first embodiment.

As shown in FIG. 13, each of the stations C and D is constructed in a way that includes packet receiving units 11, a topology map generating unit 12, inter-ring connection information 13, a packet destination selecting unit 14 and packet transmitting units 15. Objects in the system architecture of the station(s) shown in FIG. 13 are the stations C and D establishing the inter-ring connection shown in FIG. 6. On the other hand, each of the stations other than the inter-ring connecting stations (which are the stations C and D as designated in FIG. 6) is constructed in a way that includes the packet receiving units 11, the topology map generating unit 12 and the packet transmitting units 15.

Four pieces of packet receiving units 11 are provided in an interior of the station, and each identify and receive the packet forwarded from other station. In the packet identifying process, the packet is identified with, for example, a topology configuring packet or a data packet. Further, the packet receiving unit 11 includes a buffer for temporarily buffering the forwarded packet, and also functions as a congestion detecting means for, if a capacity of the buffer reaches a fixed quantity, presuming that the self-station is in a congested state and notifying the adjacent station of this congestion.

The topology map generating unit 12 generates the topology map based on pieces of information (such as a source station MAC address and a hop count that are contained in the topology configuring packet) contained in the topology configuring packet received by the packet receiving unit 11. Moreover, the topology map generating unit 12 retains the generated topology map. Then, when the packet received by the packet receiving unit 11 is identified with the data packet, a route corresponding to this packet is determined by referring to the topology map.

The inter-ring connection information 13 retains information for configuring the ring. The inter-ring connection information 13 is set based on an intention of a network administrator who desires what type of ring is configured. For instance, as shown in FIG. 11, in the case of desiring to generate such a topology map that the physical rings “#1” and “#2” are built up as one virtual ring configured by the stations such as A-B-C-F-G-D-E-A, the network administrator sets the connection information so that the packet routes become (1)-(5) and (8)-(4) in FIG. 13.

The packet destination selecting unit 14 selects (determines) the packet route corresponding to the packet received by the packet receiving unit 11. For example, when the packet received by the packet receiving unit 11 is identified with the topology configuring packet, The packet destination selecting unit 14 determines the packet route from the information set in the inter-ring connection information 13 by referring to the inter-ring connection information 13. Several patterns of this forwarding route can be considered as will be explained below. Assumed is a case in which packet input points are allocated as indicated by (1) through (8) shown in FIG. 13 in the station. Normally, when configuring the topology within the physical ring (when forwarding the topology configuring packet), in the ring “#1”, a route on an outer side is (1)-(4), and a route on an inner side is (3)-(2). Further, in the ring “#2”, a route on the outer side is (8)-(5), and a route on the inner side is (6)-(7) . On the other hand, (1)-(5), (6)-(2), (3)-(7), (8)-(4), (1)-(7), (8)-(2), (3)-(5), and (6)-(4) can be adopted as routes for configuring the topology within the virtual ring. The same forwarding routes can be also considered in the case of forwarding the packet (e.g., the data packet) other than the topology configuring packet.

Moreover, when the packet received by the packet receiving unit 11 is identified with the data packet, the packet destination selecting unit 14 determines (selects) the route corresponding to the packet by referring to the topology map. For example, a route exhibiting a minimum hop count up to the destination station is selected.

Four pieces of packet transmitting units 15 are provided in the interior of the station and each transmits the forwarded packet to the adjacent station. The packet transmitting unit 15 transmits the packet along the route selected by the packet destination selecting unit 14. Moreover, the packet transmitting unit 15 also functions as a generating means for generating a format enabling the data to be transmitted. For instance, the packet transmitting unit 15, if the packet receiving unit 11 detects the congestion of the self-station, assembles a congestion notifying packet, and this packet is sent to a adjacent station considered to be a cause of getting the self-station into the congested state. Namely, when the packet receiving unit 11 on the inner side detects the congestion, the congestion notifying packet is sent from the packet transmitting unit 15 on the outer side in the same ring.

Accordingly, in the stations shown in FIG. 13 (which are the stations C and D establishing the interconnection between the physical rings shown in FIG. 11), the packet received by the packet receiving unit 11 is identified, and hence it is possible to recognize as to whether the packet is the topology configuring packet or the data packet. Furthermore, when the packet receiving unit 11 identifies the packet with the topology configuring packet, the packet destination selecting unit 14 selects the forwarding route based on the connection information (the route information indicating the virtual ring or the physical ring in which the packet is forwarded) set in the inter-ring connection information. It is therefore feasible to forward the topology configuring packet in a way that distinguishes (judges) between the packet to be forwarded within the virtual ring (the stations A-B-C-F-G-D-E-A) and the packet to be forwarded within the physical ring (the stations A-B-C-D-E-A, or the stations G-D-C-F-G). On the other hand, when the packet receiving unit 11 identifies the packet with the data packet, the route can be determined based on the information (e.g., the hop count up to the station as the destination) of the topology map retained on the topology map generating unit 12.

<Topology Map>

Given next is an explanation of a topology map in the case of virtually generating, as shown in FIG. 11, the topology map between the plurality of rings.

The topology map is stored with an address (MAC address) of other station, an inner-side hop count up to the station, and an outer-side hop count up to the station by the self-device basis on a station-by-station.

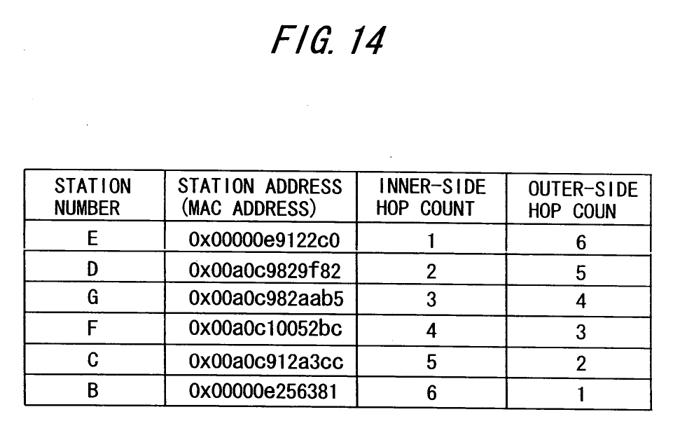

In the network shown in FIG. 11, in the case of setting, as shown in FIG. 11, one virtual ring configured across between the rings “#1” and “#2”, the topology map containing the information about all the stations (A-G) configuring the virtual ring, is generated. For instance, the topology map retained by the station A becomes as shown in FIG. 14.

<Examples of Packet Format and Forwarding of Data Packet>

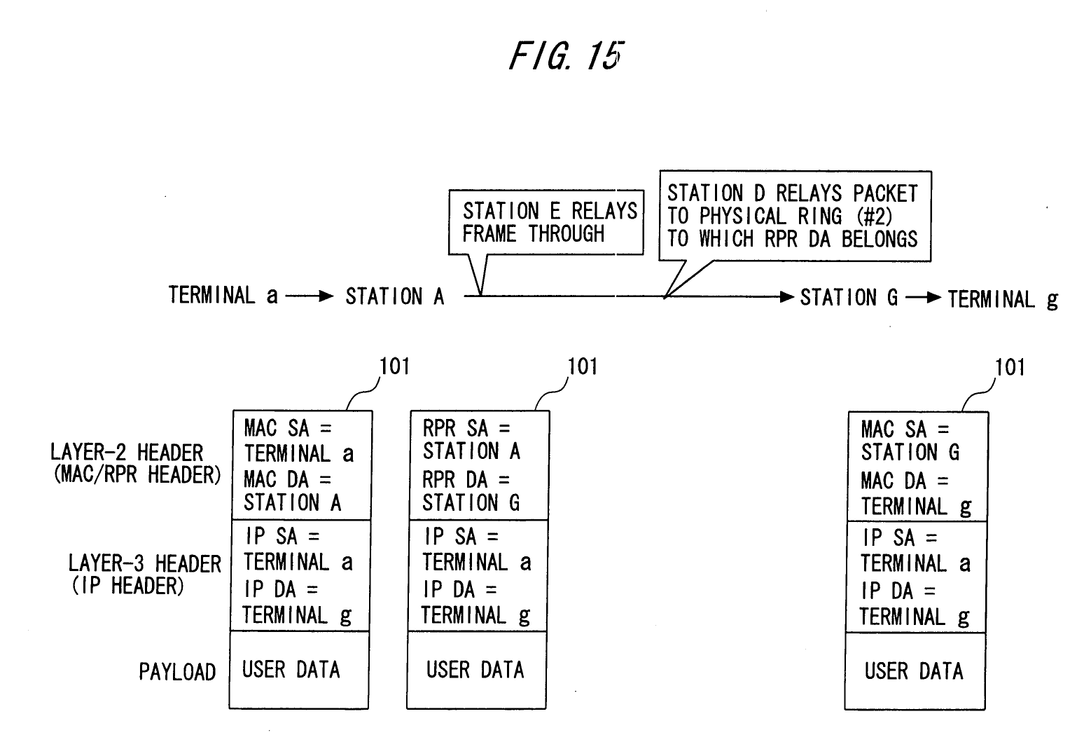

Next, an example of the packet format on the occasion of forwarding the data packet between the terminal a and the terminal g and an example of the forwarding of the data packet in the network shown in FIG. 11, will be explained with reference to FIG. 15. FIG. 15 shows a forwarding method and a packet format in the first embodiment. FIG. 15 shows the example of the format on the assumption that the data packet is forwarded to the terminal g from the terminal a.

As shown in FIG. 15, a packet format 101 of the packet forwarded between the terminal and the station is a format, wherein a payload as a data body is attached with a layer-3 header (IP header) and a MAC header serving as a layer-2 header. An IP destination address (IP DA) and an IP source address (IP SA) are set in the IP header. A MAC destination address (MAC DA) and a MAC source address (MAC SA) are set in the MAC header. The packet format 101 of the packet forwarded between the stations is a format, wherein a payload as a data body is attached with a layer-3 header (IP header) and a RPR header serving as a layer-2 header. A RPR destination address (RPR DA) and a RPR source address (RPR SA) are set in the RPR header.

The terminal a sends, to the “station A”, a packet in which the “terminal g” is set as the IP destination address of the IP header, the “terminal a” is set as the IP source address, the “station A” is set as the MAC destination address of the MAC header, and the “terminal a” is set as the MAC source address. The layer-2 header of the packet forwarded between the stations is the RPR header, and hence the station A sends, to the station g, the packet in a way that replaces the layer-2 header of the forwarded packet with the RPR header, wherein the “station G” is set as the RPR destination address (the station A previously recognizes from the IP destination address “g” that the terminal g is out of the ring to which the station G belongs), and the “station A” is set as the RPR source address. The packet to be forwarded is sent via the station E and the station D between the station A and the station G. At this time, the station E relays the packet by letting the packet “through”. Further, the station D establishing the interconnection between the rings relays the packet to the physical ring (#2) to which the RPR destination address (the station G) belongs. The station G, upon receiving the packet transferred, sends to the terminal g the packet by replacing its layer-2 header as the MAC header with a MAC header in which the “terminal g” is set as the MAC destination address, and the “station G” is set as the MAC source address.

As discussed above, the topology map of one virtual ring configured from the plurality of rings is generated, whereby each station (which is the station A in the example given above) is capable of transmitting the packet in which the station G in the different physical ring is set as the RPR destination address (the destination address on the RPR ring) of the packet to be transmitted. Namely, the station A can directly transmit the packet addressed to the station G in the adjacent ring. Hence, according to the first embodiment, the station serving as the source on the ring can directly set the address, as the destination address, not of the station establishing the inter-ring connection but of the station in the adjacent ring. Therefore, even if the fault occurs in the station establishing the inter-ring connection, it is possible to perform steering and wrapping without changing the RPR destination address on the packet ring.

<Operation and Effects>

According to the first embodiment of the present invention, the stations C and D that connect the plurality of rings are constructed as shown in FIG. 13, whereby the stations can generate the topology map of one virtual ring configured from the plurality of rings. Normally in the packet ring, each of the stations within the ring transmits the self-device information such as the MAC address to other stations within the ring by use of the topology configuring packet, thereby sharing the ring topology configuration among the stations. In the first embodiment, the stations C and D each functioning as the interconnecting point corresponding to branching point between the physical packet rings (physical rings) and the virtual packet ring (virtual ring), transmit and receive the topology configuring packet to and from the adjacent stations in the different physical rings so that the virtual packet ring is configured. Therefore, the topology map of the single virtual packet ring can be shared with all the stations, whereby the stations on the different physical rings can be recognized as the stations on the same physical ring. As a result, the ring protection such as steering and wrapping can be applied on the single virtual packet ring.

From what has been discussed so far, according to the first embodiment, in the network configured by the plurality of packet rings, the high-speed protection switchover can be conducted with only the layer-2 level by applying the conventional ring protection (such as steering and wrapping) in the packet rings without implementing the protection function (the spanning tree, etc.) on the upper layer.

### MODIFIED EXAMPLE

In the first embodiment, the station establishing the inter-ring connection, when forwarding the data packet, may determine the forwarding route based on the topology map of the virtual ring and may also determine a proper forwarding route by retaining the topology map of the physical ring (packet ring) to which the self-station belongs.

In the station establishing the interconnection between the rings, if the packet is always forwarded based on the virtual ring topology, the number of stations traversed becomes larger than in the case of forwarding the packet based on the original physical ring topology, and there might be considered a case in which efficiency of using the ring band decreases.

Such being the case, a configuration of a modified example 1 is that the station establishing the interconnection between the rings retains a topology map of the plurality of physical rings to which the station itself belongs, and the packet is forwarded on a such a route as to minimize the hop count. To be specific, the station establishing the interconnection between the rings is constructed to judge, based on the destination address in the packet header and the plurality of physical ring topologies, which route the packet is forwarded along in order to forward the packet with the minimum hop count. At this time, if the destination address does not exist in the physical ring topologies, the control is conducted to forward the packet based on the virtual ring topology.

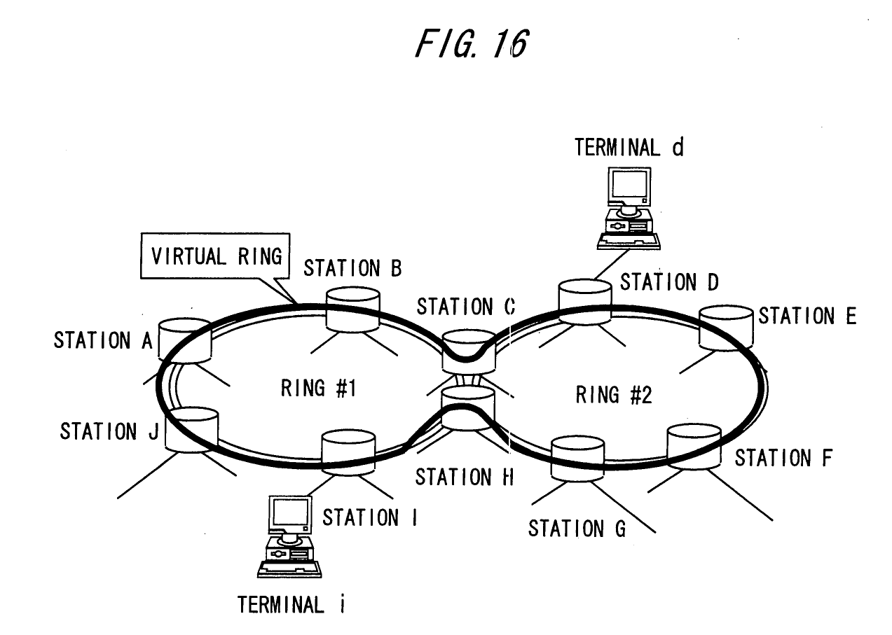

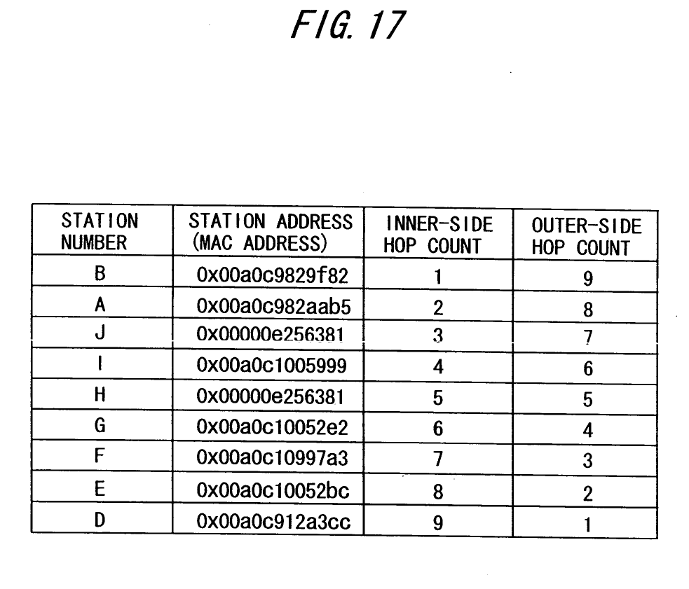

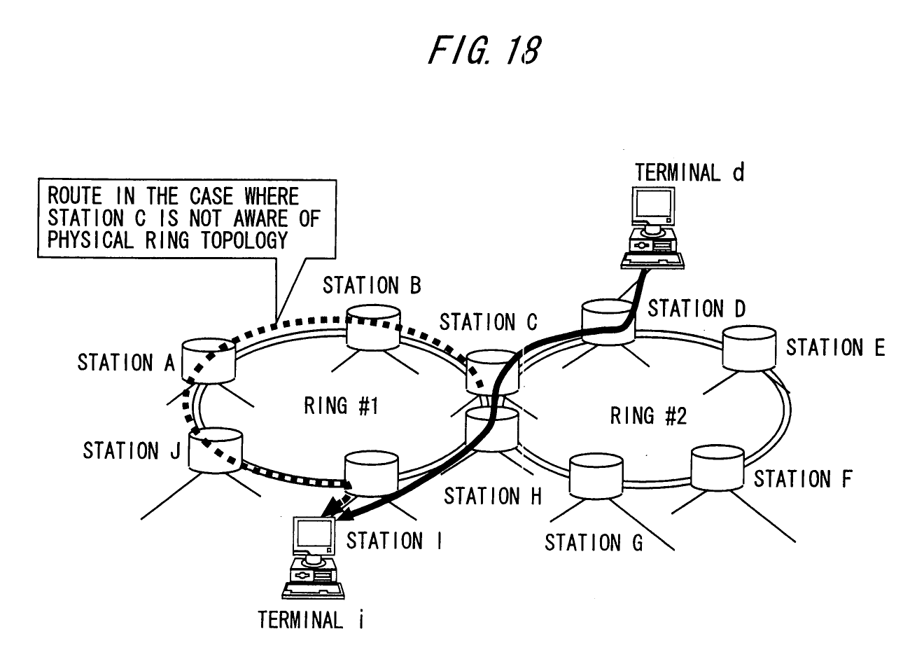

In the case of forwarding the topology configuring packet in a way that deems a network shown in FIG. 16 to be one virtual ring, the station C generates a topology map as shown in FIG. 17. Considered herein is a case of forwarding, as illustrated in FIG. 18, the packet to a station I from the station D. If the station C is not aware of the physical ring topology, the forwarding route goes such as the stations D->C->B->A->J->I. At this time, the station C, if capable of considering not the virtual ring topology alone but the actual physical ring topology, can forward the data packet by employing the forwarding route such as the stations D->C->H->I.

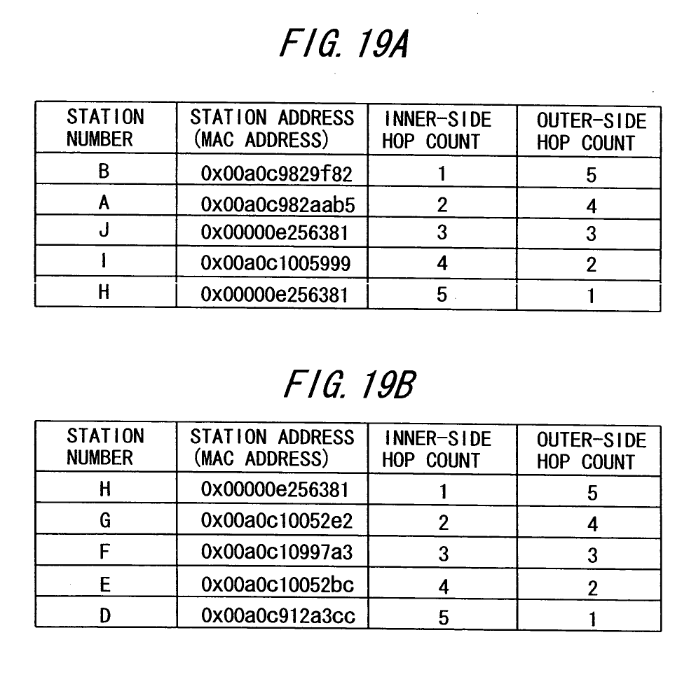

Specifically, the station C generates and retains the topology maps, shown in FIG. 19, of the respective physical rings “#1” and “#2” to which the station C itself belongs separately from the topology map of the virtual ring shown in FIG. 17, thereby making it possible to judge that the data packet addressed to the station I can reach the station I with the minimum hop count if transferred to the outer side of the ring “#1”. Herein, FIG. 19(A) shows a topology map of the ring “#1”, and FIG. 19(B) shows a topology map of the ring “#2”. For example, in the topology map of the physical ring “#1” shown in FIG. 19(A), the inner-side hop count up to the station I is “4”, while an outer-side hop count is “2”. On the other hand, in the topology map of the virtual ring shown in FIG. 17, the inner-side hop count is “4”, while the outer-side hop count is “6”. Accordingly, the station C recognizes that the route with the minimum hop count exists on the outer side of the physical ring “#1” with respect to the station I.

The station C, when the data packet is forwarded, instructs the packet destination selecting unit 14 to make the aforementioned judgment based on the physical ring topology maps and the virtual ring topology map stored on the topology map generating unit 12, and determines the forwarding route of the data packet, thus forwarding the data packet. Note that a station H establishing the interconnection between the rings similarly generates and retains the topology maps of the respective physical rings “#1” and “#2” to which the station H itself belongs, and gets capable of determining the packet route taking account of the topology of the physical rings as by the station C.

According to the modified example 1, the station establishing the interconnection between the rings retains the topology maps of all the physical rings to which the station itself belongs, whereby when the data packet is sent through the station establishing the interconnection between the rings, the route with the minimum hop count is judged based on the physical ring topology and the virtual ring topology, and the data packet is thus forwarded. Hence, according to the modified example 1, the number of stations traversed can be made smaller than in the case of determining the forwarding route based on only the topology map of the virtual ring, and consequently the efficiency of employing the ring band can be improved.

### MODIFIED EXAMPLE 2

The first embodiment may involve using a concept of a path cost that can be arbitrarily defined between the respective stations as a substitute for a concept of the hop count on the occasion of forwarding the packet along the shortest route. A configuration of a modified example 2 enables the packet to be transferred by employing such a route that this path cost takes a minimum value.

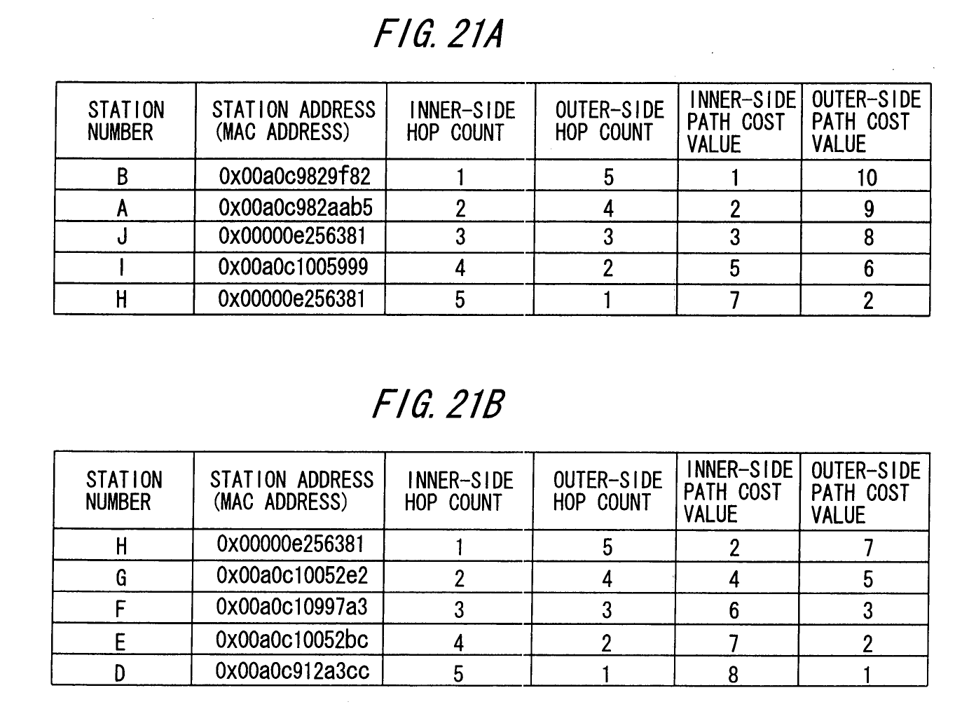

In the first embodiment, a value of the hop count is counted “1” between the stations throughout, however, the modified example 2 employs the concept termed “the path cost”replacing this hop count, which can be arbitrarily defined between the respective stations. Path cost are, as shown in FIG. 21, assigned in the topology map by giving an advertisement to each of the stations with the topology configuring packet. FIG. 21 (A) shows a topology map of the ring #1, and FIG. 21(B) shows a topology map of the ring #2.

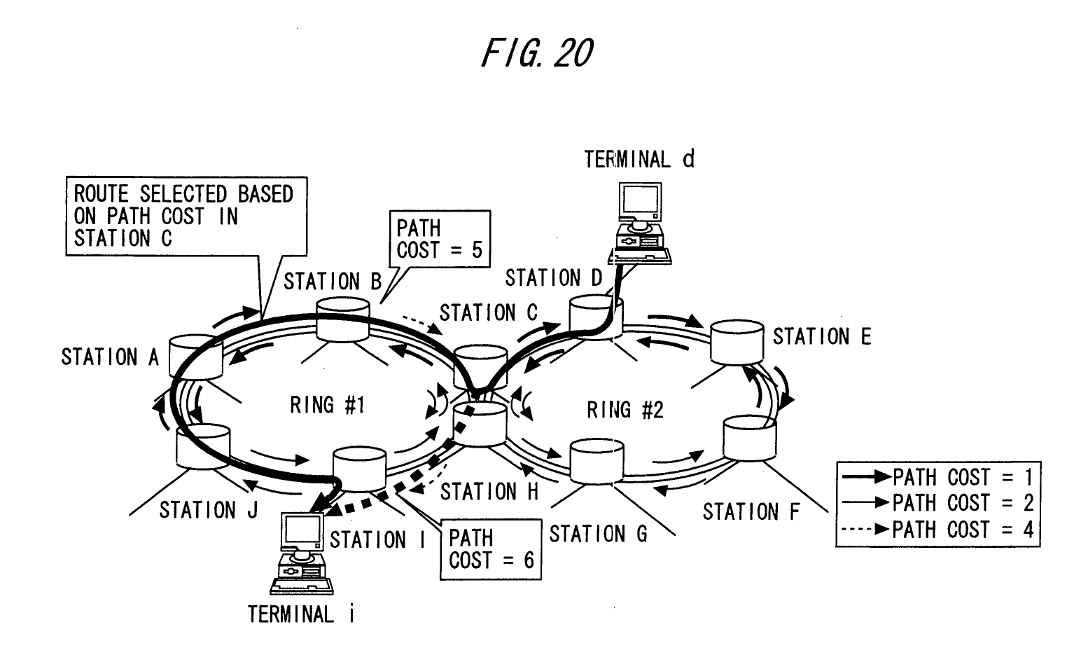

To begin with, the path costs are, as shown in FIG. 20, defined for the respective paths (upstream/downstream) among all the stations, and it may suffice that the stations establishing the interconnection between the rings can share path cost information with each other. For instance, the station C defines path cost information such as C->B (path cost=1) and C->H (path cost=2), i.e., the path cost values of the paths originating from the station C itself. The path costs are advertised together with TTL (Time-to-Live) values as carried on the topology configuring packet to other stations. For instance, as for the path costs, each station may notify of the path costs of the paths originating from the self-station together with the TTL values, and may add (calculate) the path costs.

As a result, the station C generates the physical ring topology maps and the virtual ring topology map that contain information showing how much the path cost required for reaching each station is. The station C generates respectively, for example, the physical ring topology maps as shown in FIG. 21.

In the example shown in FIG. 20, the packet is forwarded to the terminal i from the terminal d. At this time, in the station C establishing the interconnection between the rings, upon receiving the packet addressed to the terminal i (the station I), the packet destination selecting unit 14 judges from the topology map of the ring “#1” shown in FIG. 20 that a required path cost is “5” when forwarding the packet on the inner side of the ring “#1”, and the required path cost is “6” when forwarding the packet on the outer side of the ring “#1”. Hence, the station C judges that the data packet can be forwarded at the minimum path cost when forwarding the packet on the outer side of the ring “#1”, and can thus determine the forwarding route.

In the modified example 1, the judgment for gaining the minimum forwarding route involves using the hop count. Therefore, in the modified example 1, the route on the outer side of the ring “#1” is selected. While on the other hand, in the modified example 2, the judgment for gaining the minimum forwarding route involves employing the path cost. Hence, the route on the inner side of the ring “#1” is selected in the modified example 2.

Moreover, the path cost may arbitrarily be defined. For instance, a value proportional to a bandwidth between the respective stations may be defined. In this definition, a value per communication speed corresponding to the bandwidth between the stations may be defined. Owing to this definition, it is possible to perform the data transfer taking account of the communication speed between the stations.

For others, it is considered that delay time and an accounting value are defined. For defining the delay time, the delay time occurred between the stations is measured beforehand, and a value defining this measured value may be set. With this setting, the data transfer taking account of the delay time occurred on the route between the stations can be done. For defining the accounting value, there may be set a value defining a charge for using the route respectively between the stations. This setting enables the data transfer taking account of a charge for employing the path respectively between the stations.

According to the modified example 2, the path costs between the respective stations are arbitrarily defined, and the station establishing the interconnection between the rings can forward the packet by using such a route as to gain a minimum total sum of the path costs defined between the respective stations.

### MODIFIED EXAMPLE 3

The first embodiment may take a configuration that the station establishing the interconnection between the rings detects a station getting into a congested state and determines a route for forwarding the packet to steer clear of this congested station.

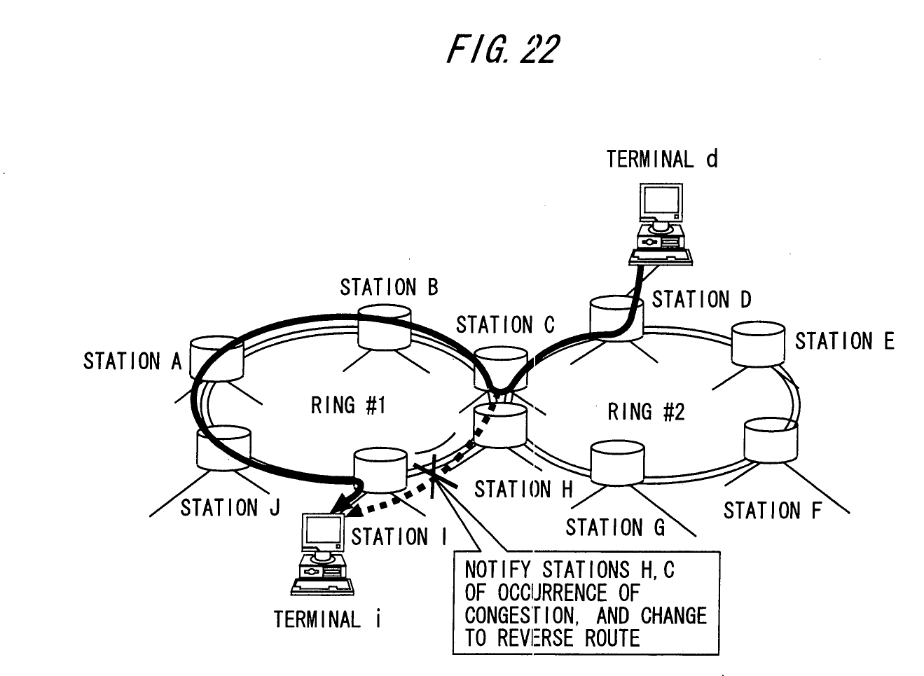

A means for avoiding congestion when the traffic gets into the congestion, will be explained by way of a modified example 3. Assumed herein is a case, wherein during the packet transfer from the terminal d to the terminal i as in the modified example 1 shown in FIG. 18, the congestion is detected by the outer-side packet receiving unit 11 of the station I as illustrated in FIG. 22.

The packet receiving unit 11 of the station I, just when the capacity in the buffer reaches the fixed quantity, judges that the self-station is in the congested state, and transmits a congestion notifying packet from the packet transmitting unit 15 in order to notify the adjacent station H of the congestion. Next, the station H restrains, based on the congestion notifying packet received from the station I, a quantity of the packet transmission to the station I from the self-station. As a result, the packet receiving unit 11 of the station H also detects the congestion, and notifies the station C of the congested state by sending the congestion notifying packet to the station C from the packet transmitting unit 15. The station C, upon receiving the congestion notifying packet, can recognize that the station C itself is in the congested state. The station C receiving the congestion notifying packet may retain, for a fixed period, a piece of information showing that the congestion was detected. For example, it is considered that the information showing that the congestion was detected is set in the topology map together with time when receiving the congestion notifying packet. With this setting, the station H can switch over the data packet forwarding route to a reversed route (via the stations C-B-A-J-I). Here at, if the congestion notifying packet is not again received even when a fixed period of time elapses, the forwarding route may be set back to the original route. Accordingly, the station establishing the interconnection between the rings can, in the case of getting into the congested state, perform the control of switching over the packet route to the destination station irrespective of the hop count and the path cost value.

According to the modified example 3, it is possible to steer clear of the congested point by forwarding the packet along the route that does not traverse the station where the congestion occurs. Hence, according to the modified example 3, it is feasible to actualize the packet transfer with higher efficiency at a lower packet discarding rate.

### MODIFIED EXAMPLE 4

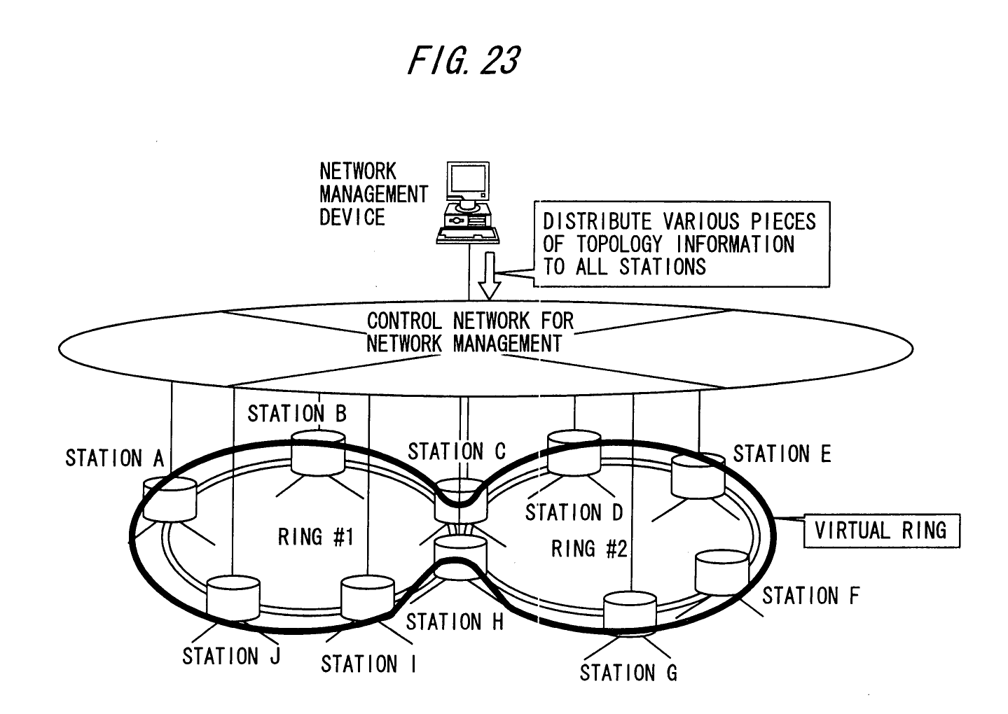

The first embodiment may take such a configuration as to install, as shown in FIG. 23, a high-order network management device for managing all the stations existing in the network. The high-order network management device is constructed by employing an information processing device such as a personal computer, a workstation, etc. and functions as a control device for managing a subordinate network.

The assumption in the examples explained so far is that the means for configuring the virtual ring topology and the physical ring topology involves transmitting and receiving the topology configuring packet between the stations. In a modified example 4, the high-order network management device manages pieces of topology information about the virtual ring and the physical rings in all the stations, and distributes the topology information and information attached thereto to all the stations. Namely, a scheme in the modified example 4 is not that the virtual ring topology map and the physical ring topology map are generated by using the topology configuring packet, but that the high-order network management device grasps the topologies of all the stations and distributes the topology information and the information attached thereto to all the stations. Each station determines the forwarding route based on the distributed topology information and the information attached thereto.

According to the modified example 4, the high-order network management device is disposed above the plurality of packet rings, whereby the whole of the plural packet rings interconnected to each other can be controlled. Further, the high-order network management device is disposed above the plurality of packet rings and is made to manage the physical ring topologies of other stations that do not establish the interconnection between the rings, whereby the data can be, it is also considered, transferred along the shortest route taking account of the physical ring topologies of all the stations existing in the packet rings.

### Second Embodiment

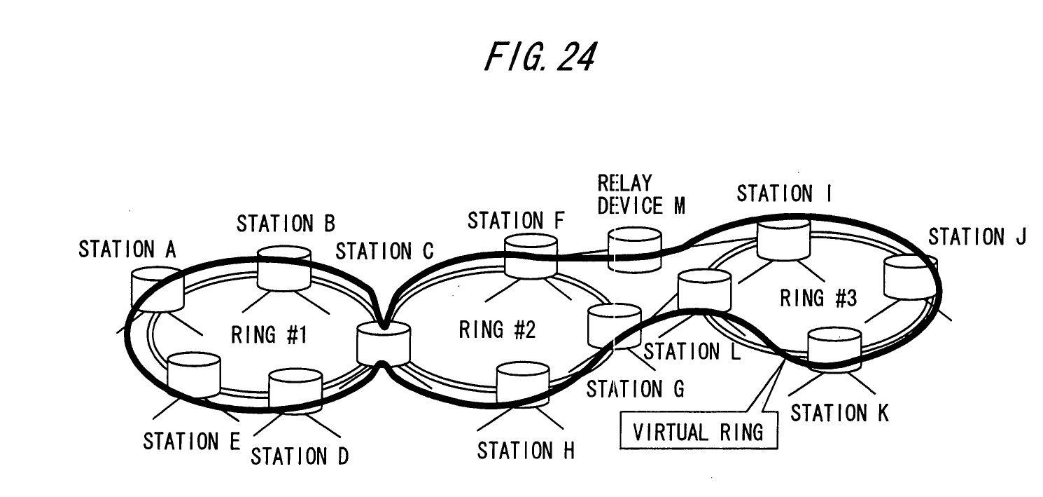

Next, a second embodiment for actualizing the present invention will be described with reference to FIGS. 24 through 29.

<Outline>

A network architecture in the second embodiment for actualizing the present invention will be explained referring to FIG. 24. FIG. 24 shows one example of the network architecture configured by a plurality of packet rings and a relay device. A different point of the second embodiment from the first embodiment is that the network architecture includes an in-between relay device utilizing different protocols for establishing the connections between the physical packet rings (physical rings). The following is a discussion mainly on the different point.

The network illustrated in FIG. 24 includes packet rings “#1”, “#2” and “#3”. The packet rings “#1” and “#2” are interconnected by the station C. The packet rings “#2” and “#3” are interconnected via a relay device M by the stations F and I and also by stations G and L. It is assumed that the packet rings “#2” and “#3” are all interconnected through Ethernet.

In the second embodiment, one station establishing the interconnection between the rings encapsulates the topology configuring packet and the data packet to be transferred to another station on other ring into frames corresponding to a type of line that connects the rings, and sends the encapsulated packets to other station. In the network shown in FIG. 24, an Ethernet frame encapsulates the topology configuring packet and the data packet to be transferred between the station F, the relay device M and the station I, and between the station G and the station L.

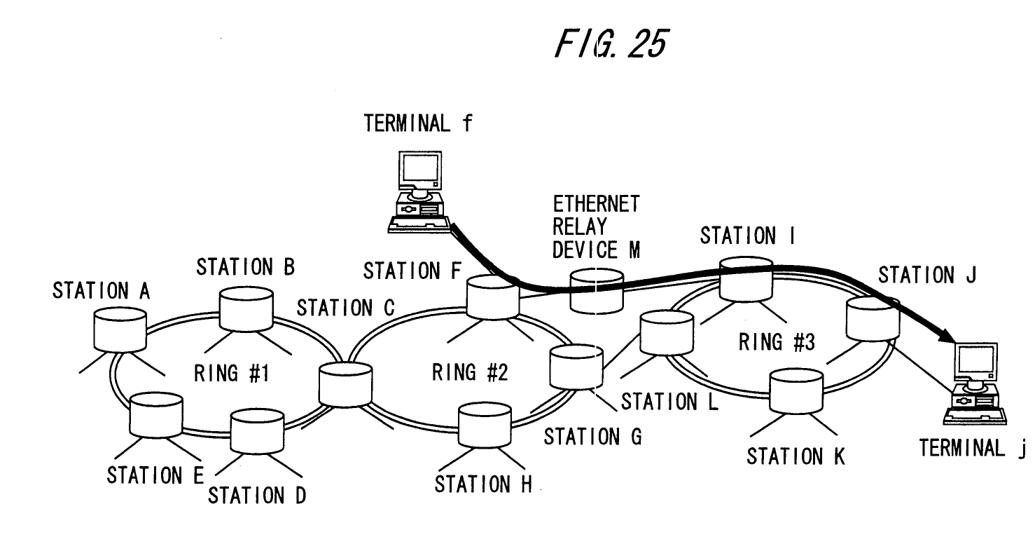

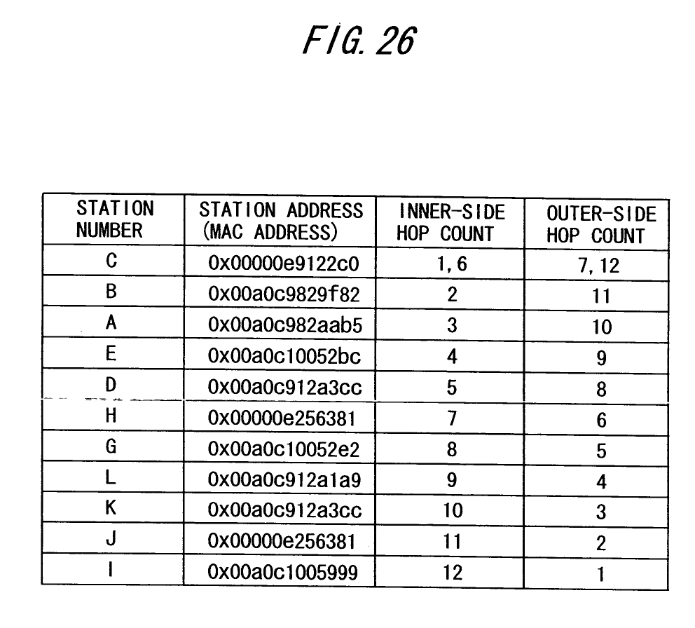

FIG. 25 shows an example of forwarding the packet along a route between a terminal f and a terminal j in the network architecture shown in FIG. 24. At this time, the station F generates a topology map shown in, e.g., FIG. 26. Note that the system architecture of the station and the topology map generating method are the same as those in the first embodiment, and hence their explanations are omitted.

Further, the second embodiment uses the relay device M interposed for connecting the packet rings “#2” and “#3”, and may also take an architecture employing a relay network configured by connecting a plurality of relay devices as a substitute for the relay device M.

<Packet Format and Example of Packet Transfer>

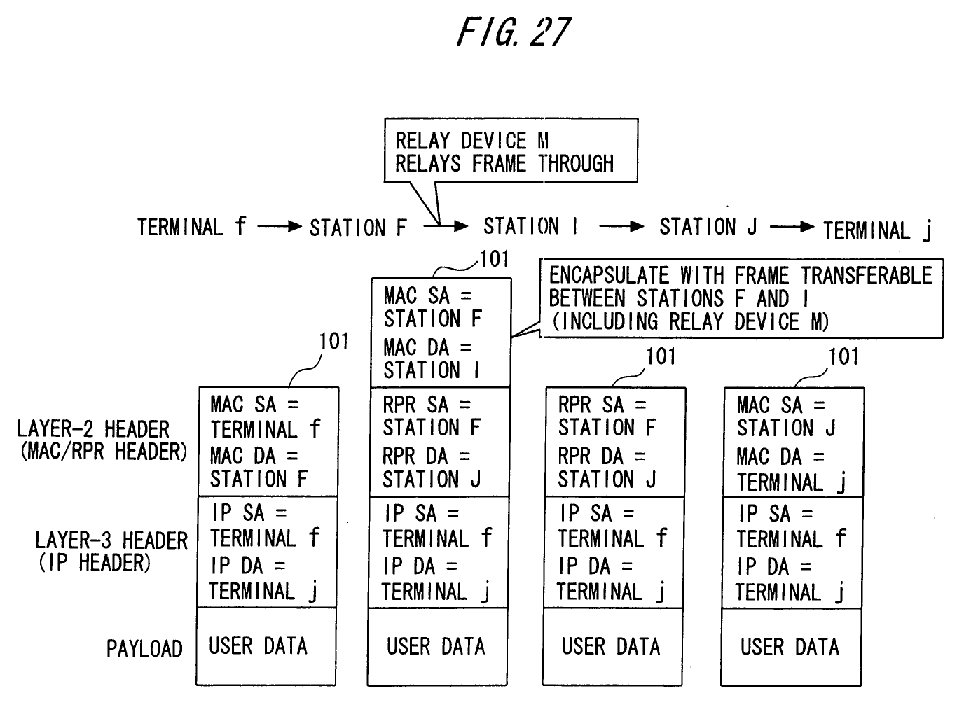

Next, in a network architecture shown in FIG. 25, a packet format and an example of the packet transfer on the occasion of transferring the data packet between the terminal f and the terminal j, will be explained with reference to FIG. 27. FIG. 27 shows a transfer method and a packet format in the second embodiment. FIG. 27 shows the example of the format that presumes a case of transferring the data packet to the terminal j from the terminal f. The second embodiment has, in the example shown in FIG. 27, the different packet format and the different transfer method of the packet transferred between the station F and the station I from those in the first embodiment. In the following discussion, mainly different points from the first embodiment will be described.

As shown in FIG. 27, in a packet format 101 of the packet transferred between the station F and the station I that are connected by the relay device M, a payload corresponding to a data body is attached with a layer-3 header (IP header) and an RPR header as a layer-2 header, and further the packet is encapsulated with a MAC header. Namely, the data packet transferred between the station F and the station I is encapsulated into the transferable frame corresponding to the line. A MAC destination address (MAC DA) and a MAC source address (MAC SA) are set in the MAC header.

In the case of transferring the data packet to the terminal j from the terminal f, in the station F, the MAC frame encapsulates the data packet transferred. The encapsulation of the data packet is conducted by a generating means provided in the packet transmitting unit 15 within the station. At this time, the station F sends, to the station I, a packet in which the “station I” is set as the MAC destination address of the MAC header, and the “station F” is set as the MAC source address. Namely, the packet, in which the “station I” in the adjacent ring is set as the destination, is sent from the station F. The data packet transferred between the station F and the station I is sent via the relay device M. The relay device M functions to relay the frame to the station I in a way that lets the data packet transferred from the station F through as it is. The station I transfers, to the station J, the data packet detaching the MAC header from the data packet transferred. The subsequent processes are the same as those in the first embodiment.

<Saving of Packet>

Given next is an explanation of a packet saving method effective particularly in a case where the station configuring the packet ring encounters an occurrence of a fault that can not be detected by the adjacent station due to an occurrence of a software fault, etc., i.e., a fault that is difficult to effect the ring protection.

Given further is a description of a packet saving method effective in a case where there is one station establishing the interconnection between the rings as in the network architecture in the second embodiment and the protection switchover is difficult to perform even in the case of a fault that can be detected by the adjacent station.

An assumption is a case of forwarding the packet on the basis of only the physical ring topology without sharing any virtual packet ring topology in the network configured by the plurality of packet rings (physical rings) At this time, the destination of the packet to be transferred across the plurality of physical rings is an address of the station establishing the interconnection between the rings. The station that connects the rings to each other, after receiving the packet, needs to forward the packet to the physical ring in a way that replaces the destination of the packet with an address of the destination station existing in the next physical ring. Herein, in the case of setting to execute the forced path-through between the different physical rings due to a fault occurred in the station establishing the interconnection between the rings, it follows that the destination of the packet remains to be the station establishing the interconnection between the rings without being replaced, and the packet is transferred as it is to the next physical ring. Thereafter, the packet becomes address unknown and unreachable and might be discarded.

Accordingly, in the second embodiment, the station establishing the interconnection between the rings, when detecting the fault in the self-device, executes the forced path-through setting by use of the forwarding route based on the virtual ring topology, thereby actualizing the saving of the packet sent via the station establishing the interconnection between the rings without discarding the packet. The packet saving exhibits an effect in the present invention, wherein the data is transferred across the plurality of physical rings in such a way that all the stations share the topology map of one virtual packet ring with each other, and each station directly transmits the packet addressed to the station in the different physical ring.

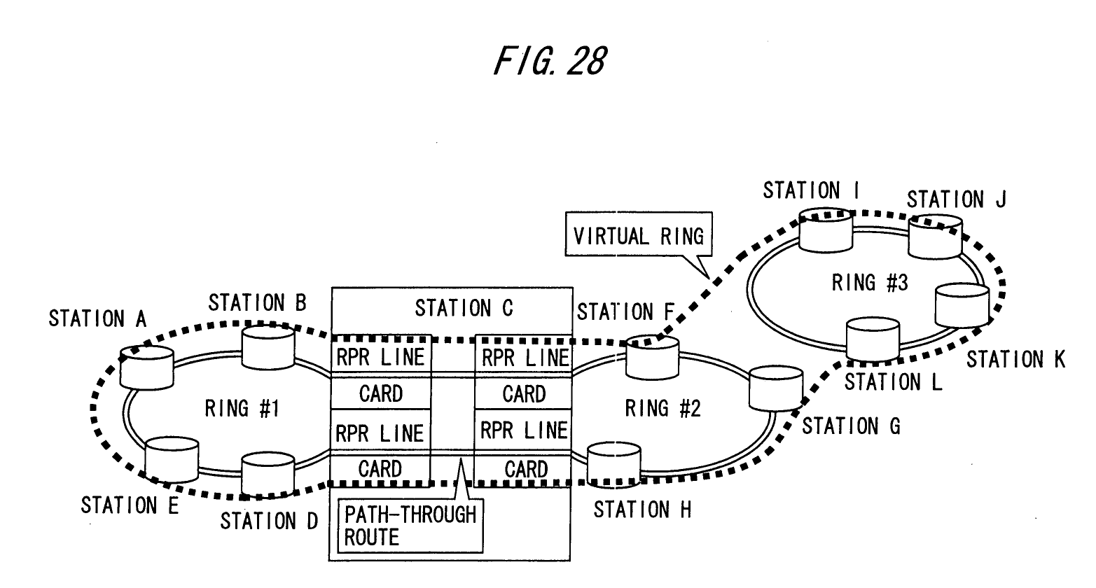

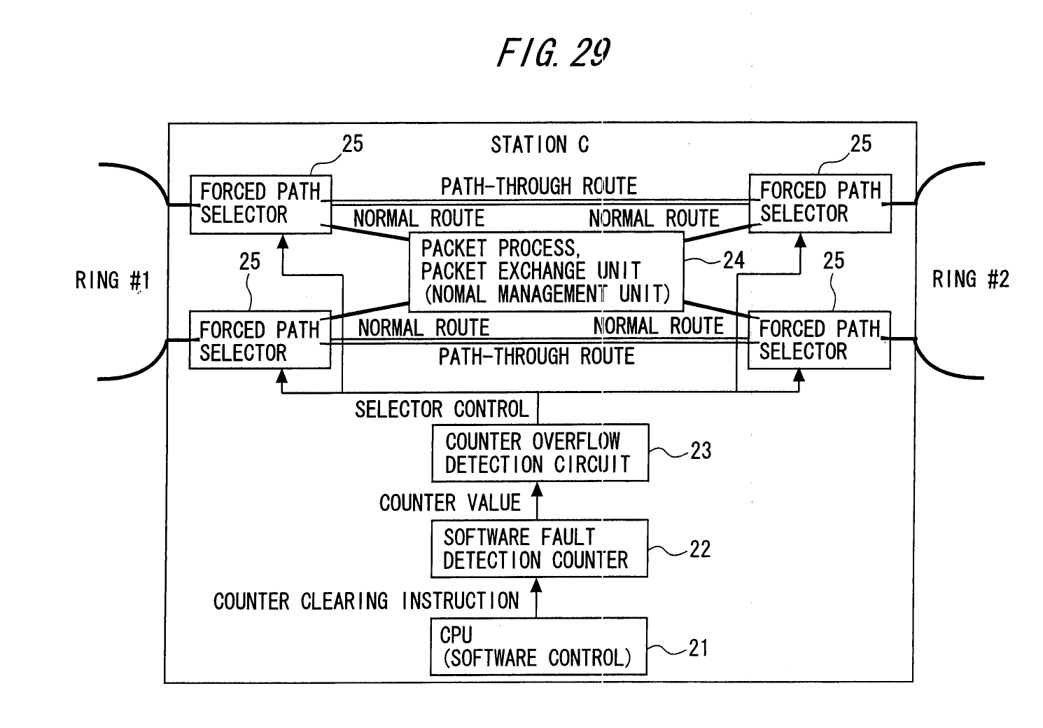

Specifically, the saving method in the case of the occurrence of the fault that is hard to be detected in the adjacent station due to the occurrence of the software fault etc., within the interior of the station C establishing the inter connection between the rings, will be explained with reference to FIGS. 28 and 29.

If the software fault occurs, the station C saves the packet transferred between the rings by autonomously setting the path-through by hardware as shown in FIG. 28. The path-through route shown in FIG. 28 represents a route built up by establishing a forced connection between the rings. Four cards existing on the RPR line shown in FIG. 28 function as interfaces between the rings. Further, each of the four card units shown in FIG. 28 functions as part of a forced path selector 25 and a packet processing/packet switching unit 24 in the system illustrated in FIG. 29.

FIG. 29 shows an example of a system architecture in the station C for actualizing the path-through. The station C is constructed by including a CPU 21 for controlling the software, a software fault detection counter 22, a counter overflow detection circuit 23, a packet processing/packet switching unit 24 and four forced path selectors 25.

The software fault detection counter 22 detects a software fault. The software fault detection counter 22 is always counted up, and the CPU 21 periodically gives a counter clearing instruction by controlling the software before the counter overflows. Namely, a counter value invariably comes to zero with a fixed period. The counter overflow detection circuit 23 monitors the counter value of the software fault detection counter 22. If the software fault occurs, the counter is not cleared with the result that the counter value overflows. For example, if the counter value all becomes 1 (if the counter value overflows), the counter overflow detection circuit 23 judges that the counter clearing instruction is stopped due to the software fault, and gives a selector instruction that makes the forced path selector 25 forcibly (hardwarewise) select a path-through route. The forced path selector 25 exists at an interface with each ring, and switches over the normal route via the packet processing/packet switching unit 24 constructed of a switch to the path-through route along the virtual ring topology.

Through this operation, the forced connection between the rings “#1” and “#2” can be established hardwarewise along the virtual ring topology, and the packet traversed between the rings can be saved. Moreover, as by the station C shown in FIG. 28, even when the rings are connected by the single station, the packet transferred across between the rings can be saved.

<Operation and Effects>

According to the second embodiment of the present invention, when connecting the plurality of physical packet rings (physical rings), one virtual packet ring (virtual ring) can be configured by directly connecting the respective stations belonging to the respective physical rings or by connecting the stations via the network relay device without employing the station belonging to the plurality of rings. Therefore, according to the second embodiment, the interconnection between the physical rings can be established by employing the device other than the stations existing on the packet rings, and it is possible to configure the more flexible virtual ring than in the first embodiment.

Furthermore, according to the second embodiment, in case there occurs the fault impossible of being detected by the adjacent device, i.e., the software fault etc. in the station establishing the connection between the packet rings (physical rings) and making the ring protection unable to be executed, and even if there is the single station establishing the interconnection between the rings and if impossible of switching over the packet route, the packet transferred across between the rings can be saved.

### INDUSTRIAL APPLICABILITY

The present invention can be applied to the system that configures the network by use of the RPR rings.

<Others>

The disclosures of international application PCT/JP2003/005269, filed on Apr. 24, 2003 including the specification, drawings and abstract are incorporated herein by reference.

1. An inter-ring connection device functioning as one of network devices belonging to at least one of physical rings, each of the physical rings being configured by any of the network devices, at least two of the network devices being provided in order to connect two of the physical rings, each of the network devices sending topology configuring data containing its own address and information indicating its own position onto the at least one of physical rings, receiving the topology configuring data from each of the network devices, and generating a topology map, the inter-ring connection device comprising:
a setting information storage unit storing setting information generating a topology map of a physical ring or setting information generating a topology map of a virtual ring striding over the physical rings; and
a transferring unit transferring, when transferring the topology configuring data to an adjacent network device of the network devices, if the setting information stored on said setting information storage unit is the setting information generating the topology map of the physical ring, the topology configuring data to the other adjacent network device on the physical ring to which the adjacent network device being a source network device of the topology configuring data belongs, and transferring, if the setting information is the setting information generating the topology map of the virtual ring, the topology configuring data to the other adjacent network device on the physical ring being different from the physical ring to which the adjacent network device being a source network device of the topology configuring data belongs.

2. An inter-ring connection device according to claim 1, further comprising:
a retaining unit retaining the topology map of each of the physical rings being connected by the inter-ring connection device; and
a route determining unit determining, when receiving data set based on the topology map of the virtual ring and containing information regarding a source network device and a destination network device striding over the physical rings, a shortest route, on the physical ring to which the destination network device belongs, from the inter-ring connection device to the destination network device by referring to the topology map of the physical ring to which the destination network device belongs,
wherein said transferring unit transfers the data to the adjacent network device located on the shortest route based on a result of the determination by said route determining unit.

3. An inter-ring connection device according to claim 2, wherein said route determining unit determines a minimum hop count as the shortest route based on a hop count between the inter-ring connection device and the destination network device.

4. An inter-ring connection device according to claim 2, wherein said route determining unit determines, as the shortest route, a minimum total sum of cost values between the network devices on the physical rings and between the inter-ring connection device and the other network devices.

5. An inter-ring connection device according to claim 2, further comprising
a notification-of-congestion receiving unit receiving a notification of congestion indicating a congestion of each of the network devices from the network devices,
wherein said route determining unit, when receiving the notification of congestion, determines a route bypassing the network device occurring the congestion, for the data to be transferred to the physical ring to which a source network device of the notification of congestion belongs.

6. An inter-ring connection device functioning as one of network devices belonging to at least one of physical rings, each of the physical rings being configured by any of the network devices, at least one of the network devices being provided in order to connect two of the physical rings, each of the network devices sending topology configuring data containing its own address and information indicating its own position onto the at least one of physical rings, receiving the topology configuring data from each of the network devices, and generating a topology map, the inter-ring connection device comprising:
a setting information storage unit storing setting information generating a topology map of a physical ring or setting information generating a topology map of a virtual ring striding over the physical rings; and
a transferring unit transferring, when transferring the topology configuring data to an adjacent network device of the network devices, if the setting information stored on said setting information storage unit is the setting information generating the topology map of the physical ring, the topology configuring data to the other adjacent network device on the physical ring to which the adjacent network device being a source network device of the topology configuring data belongs, and transferring, if the setting information is the setting information generating the topology map of the virtual ring, the topology configuring data to the other adjacent network device on the physical ring being different from the physical ring to which the adjacent network device being a source network device of the topology configuring data belongs;
a switching line transferring the data striding over the physical rings through a pass switch in the inter-ring connection device;
a path through line directly transferring the data striding over the physical rings not through the pass switch in the inter-ring connection device;
a fault detecting unit detecting a fault of control unit executing software performed as the inter-ring connection device; and
a switching unit switching over, when the fault is detected by said fault detecting unit, a line transferring the data striding over the physical rings from said switching line to said path through line.

7. An inter-ring connection device functioning as one of network devices belonging to at least one of physical rings, each of the physical rings being configured by any of the network devices, each of the network devices sending topology configuring data containing its own address and information indicating its own position onto the at least one of physical rings, receiving the topology configuring data from each of the network devices, generating a topology map, and transferring data between a predetermined network device of the network devices on the other physical rings, the inter-ring connection device comprising:
a setting information storage unit storing setting information generating a topology map of a physical ring or setting information generating a topology map of a virtual ring striding over the physical rings; and
a transferring unit transferring, when transferring the topology configuring data to the other network device, if the setting information stored on said setting information storage unit is the setting information generating the topology map of the physical ring, the topology configuring data to the other network device on the physical ring to which its own network device belongs, and transferring, if the setting information is the setting information generating the topology map of the virtual ring, the topology configuring data to the predetermined network device.

8. An inter-ring connection device according to claim 7, wherein the inter-ring connection device is connected to the predetermined network device with a relay network using a protocol different from a protocol used on the physical rings, translates the topology configuring data received from the adjacent network device into a format corresponding to the relay network; and sends the data to the predetermined network device.

9. A data transfer control method of an inter-ring connection device, the inter-ring connection device functioning as one of network devices belonging to at least one of physical rings, each of the physical rings being configured by any of the network devices, at least two of the network devices being provided in order to connect two of the physical rings, each of the network devices sending topology configuring data containing its own address and information indicating its own position onto the at least one of physical rings, receiving the topology configuring data from each of the network devices, and generating a topology map, the data transfer control method comprising the steps of:
receiving the topology configuring data from an adjacent network device of the network devices; and
transferring, when transferring the received topology configuring data to the adjacent network device, if setting information generating the topology map of the physical ring is set as setting information of data transfer, the topology configuring data to the other adjacent network device on the physical ring to which the adjacent network device being a source network device of the topology configuring data belongs, and transferring, if setting information generating the topology map of the virtual ring is set as the setting information of data transfer, the topology configuring data to the other adjacent network device on the physical ring being different from the physical ring to which the adjacent network device being a source network device of the topology configuring data belongs.

10. A data transfer control method of an inter-ring connection device according to claim 9, further comprising the steps of:
retaining the topology map of each of the physical rings being connected by the inter-ring connection device;
determining, when receiving data set based on the topology map of the virtual ring and containing information regarding a source network device and a destination network device striding over the physical rings, a shortest route, on the physical ring to which the destination network device belongs, from the inter-ring connection device to the destination network device by referring to the topology map of the physical ring to which the destination network device belongs; and
transferring the data to the adjacent network device located on the shortest route based on a result of the determination.

11. A data transfer control method of an inter-ring connection device according to claim 10, wherein said step of determining the shortest route determines a minimum hop count as the shortest route based on a hop count between the inter-ring connection device and the destination network device.

12. A data transfer control method of an inter-ring connection device according to claim 10, wherein said step of determining the shortest route determines, as the shortest route, a minimum total sum of cost values between the network devices on the physical rings and between the inter-ring connection device and the other network devices.

13. A data transfer control method of an inter-ring connection device according to claim 10, further comprising the steps of:
receiving a notification of congestion indicating a congestion of each of the network devices from the network devices; and
determining, when receiving the notification of congestion, a route bypassing the network device occurring the congestion, for the data to be transferred to the physical ring to which a source network device of the notification of congestion belongs.

14. A data transfer control method of an inter-ring connection device, the inter-ring connection device functioning as one of network devices belonging to at least one of physical rings, each of the physical rings being configured by any of the network devices, at least one of the network devices being provided in order to connect two of the physical rings, each of the network devices sending topology configuring data containing its own address and information indicating its own position onto the at least one of physical rings, receiving the topology configuring data from each of the network devices, and generating a topology map, the data transfer control method comprising the steps of:
receiving the topology configuring data from an adjacent network device of the network devices;
transferring, when transferring the received topology configuring data to the adjacent network device, if setting information generating the topology map of the physical ring is set as setting information of data transfer, the topology configuring data to the other adjacent network device on the physical ring to which the adjacent network device being a source network device of the topology configuring data belongs, and transferring, if setting information generating the topology map of the virtual ring is set as the setting information of data transfer, the topology configuring data to the other adjacent network device on the physical ring being different from the physical ring to which the adjacent network device being a source network device of the topology configuring data belongs;
transferring, if any fault does not occur on control unit executing software installed on the inter-ring connection device when relaying the data to be transferred striding over the physical rings based on the topology map of the virtual ring configured to stride over the physical rings, the data along a switching line of the switching line transferring the data striding over the physical rings through a pass switch in the inter-ring connection device and a path through line directly transferring the data striding over the physical rings not through the pass switch; and
transferring, if the fault in said control unit is detected, the data along the path through line by switching over the transfer line from the switching line to the path through line.

15. A data transfer control method of an inter-ring connection device, the inter-ring connection device functioning as one of network devices belonging to at least one of physical rings, each of the physical rings being configured by any of the network devices, each of the network devices sending topology configuring data containing its own address and information indicating its own position onto the at least one of physical rings, receiving the topology configuring data from each of the network devices, generating a topology map, and transferring data between a predetermined network device of the network devices on the other physical rings, the data transfer control method comprising the steps of:
receiving the topology configuring data from an adjacent network device of the network devices; and
transferring, when transferring the received topology configuring data to the other network device, if setting information generating the topology map of the physical ring is set as setting information of data transfer, the topology configuring data to the other network device on the physical ring to which the network device being a source network device of the topology configuring data belongs, and transferring, if the setting information is the setting information generating the topology map of the virtual ring, the topology configuring data to the predetermined network device.

16. A data transfer control method of an inter-ring connection device according to claim 15, wherein said step of transferring the topology configuring data translates, when connected to the predetermined network device with a relay network using a protocol different from a protocol used on the physical rings, the topology configuring data received from the adjacent network device into a format corresponding to the relay network, and sends the data to the predetermined network.
